(19) United States
(12) Patent Application Publication
(10) Pub. No.: US 2014/0012652 A1
(43) Pub. Date: Jan. 9, 2014

(54) SYSTEM AND METHOD FOR REDUCING LOYALTY POINT LIABILITY THROUGH GAMING

(71) Applicant: IGT, Las Vegas, NV (US)

(72) Inventors: Woodrow H. Levin, San Francisco, CA (US); Joseph G. Moss, Danville, CA (US); Michael A. Burlando, San Francisco, CA (US)

(21) Appl. No.: 13/934,886

(22) Filed: Jul. 3, 2013

Related U.S. Application Data
(60) Provisional application No. 61/668,665, filed on Jul. 6, 2012.

(51) Int. Cl. G06Q 30/02

(52) U.S. Cl. CPC G06Q 30/0233
USPC 705/14.31

(57) ABSTRACT

Various embodiments of the present disclosure are directed to a system and method to reducing loyalty point liability through gaming. The system enables a member of a loyalty program provided by a loyalty program provider to use the member's accumulated loyalty points to play one or more games in one of a variety of different play modes. The system enables the member to win loyalty points or other suitable awards through game play. The system employs one or more mechanisms to cause loyalty points to be removed from circulation; that is, the system causes loyalty point providers to remove loyalty points from members' loyalty point balances, thereby removing those loyalty points from the loyalty program providers' balance sheets. The system is configured such that, over time, more loyalty points are removed from circulation via these mechanisms than are added to circulation through awards provided to members through game play.

### PRIORITY CLAIM

This application claims priority to and the benefit of U.S. Provisional Patent Application No. 81/868,665, filed on Jul. 8, 2012, the entire contents of which are incorporated herein by reference.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Many organizations offer consumer-oriented loyalty programs in which members accumulate loyalty points that are redeemable for one or more of a variety of rewards. These loyalty programs, such as frequent flyer programs, credit card reward programs, hotel chain reward programs, retail store reward programs, and the like, give out an estimated $48 billion every year in reward points in the United States alone. An estimated one-third of those reward points—valued at an estimated $16 billion—go unredeemed each year. Thus, day after day, month after month, and year after year the total quantity of unredeemed loyalty points keeps growing. The result of such large, continuously growing quantities of unredeemed loyalty points is that the airlines, banks, hotels, retail companies, and other organizations that provide such loyalty programs to reward their customers and loyalty program members carry large loyalty point liabilities on their balance sheets.

More specifically, each loyalty point is associated with a certain value, such as a value in U.S. dollars. Thus, each unredeemed loyalty point of an organization's loyalty program is an obligation that that organization owes (upon redemption of that loyalty point) to the loyalty program member who “owns” that loyalty point. An organization having billions upon billions of unredeemed loyalty points in circulation could, therefore, have millions or even billions of dollars worth of obligations on its balance sheet that may become due at any point in time. In certain instances, such an organization sets aside enough funds to cover for these loyalty point liabilities, which is problematic because the liabilities may never become due (should the loyalty points not be redeemed), thus requiring the funds to be indefinitely set aside and not otherwise be used to benefit the company (and its loyalty program members). In other instances, such an organization does not set aside enough funds to cover for such loyalty point liabilities, which is problematic because the organization would not be able to fulfill its obligations should many of those loyalty points be redeemed at about the same time. In further instances, the value of such an organization may be less than its obligations owed to loyalty program members.

Various reasons exist as to why such a large quantity of loyalty points go unredeemed. One reason is that certain members of loyalty programs may not have accumulated enough loyalty points to redeem them for a reward, such as a free flight, a free night's stay in a hotel or a discount on a purchase. Another reason is that certain members of loyalty programs may not like or have use for the available rewards for which they may redeem their loyalty points. For example, a member may have no reason or desire to fly, and thus has no reason or desire to redeem her frequent flyer miles for a free flight. An additional reason is that certain members of loyalty programs may not remember that they have loyalty point balances. Another reason is that certain members of loyalty programs may be saving their loyalty points so that they may redeem them for a more valuable reward in the future should they accumulate enough loyalty points. For example, a member may save her loyalty points for five years to redeem them for free vacation flights for her family. An additional reason is that certain members of loyalty programs may find it a waste to spend the time to redeem their loyalty points for rewards that they feel are worthless or useless, such as an oversized t-shirt including the loyalty program provider's logo.

One solution that was formerly implemented by many organizations was automatic expiration of loyalty points after a certain period of time. For instance, an organization implementing such a solution would remove any unredeemed loyalty points from a loyalty program member's loyalty point balance one year after providing those loyalty points to the loyalty program member. Over the years, however, most organizations abandoned such a policy due to complaints from loyalty program members. Now, many organizations do not cause loyalty points to expire as long as loyalty program members at least periodically keep their loyalty program accounts active. For instance, a credit card company may require at least one monthly transaction using its credit card to keep a member's loyalty program account active.

A need thus exists to reduce the loyalty point liability of loyalty program providers by enabling loyalty program members to use their accumulated loyalty points in new, exciting, and engaging ways.

### SUMMARY

Nearly 141 million people in the United States, which is about 66% of the current population of the United States, play casual games such as Solitaire, Minesweeper, or other relatively simple, easy to learn games for fun. In fact, the United States population will spend about 50 million hours this year alone playing casual games for their enjoyment. Many others wager on and play games of chance such as slot games, blackjack games, roulette games, poker games, and keno games either online or at one or more land-based gaming establishments, such as casinos. Certain persons play such games of chance using virtual or non-monetary currency, while others play such games of chance using monetary currency. Many others play lottery games or enter drawings in which they have a chance to win one or more awards.

Various embodiments of the present disclosure are directed to a system and method for reducing loyalty point liability through gaming. Generally, the loyalty point reduction system of the present disclosure enables a member of a loyalty program provided by a loyalty program provider to use the member's accumulated loyalty points to play one or more games, such as skill games or games of chance, in one of a variety of different play modes. In certain embodiments, the system enables the member to win loyalty points through play of the games. In other embodiments, the system enables the member to win awards other than loyalty points through play of the games. In further embodiments, the system does not enable the member to win any awards through play of the games. In various embodiments, the system employs one or more mechanisms to cause loyalty points to be removed from circulation; that is, the system causes loyalty point providers to remove loyalty points from members' loyalty point balances, thereby removing those loyalty points from the loyalty program providers' balance sheets. The system is configured such that, over time, more loyalty points are removed from circulation via these mechanisms than are added to circulation through loyalty point awards (if any) provided to members through game play.

In one embodiment, the system receives a request from a member of a loyalty program provided by a loyalty program provider to access a gaming user interface of the system and to use the gaming user interface to play one of a plurality of different games. In various embodiments, the system receives such a request through a website hosted or maintained by the loyalty program provider, through a website hosted or maintained by the system, or through an application installed on a member access device of the member (such as a smart phone or a tablet computer). The system receives a request from the member to play the requested game in one of one or more different play modes. The system determines and displays an entry fee associated with the requested game and the requested play mode. The entry fee includes a designated quantity of loyalty points. The system instructs the loyalty program provider to deduct the entry fee from a loyalty point balance of the member. The system displays a play of the requested game in the requested play mode, determines an outcome for the play, and determines any loyalty point awards based on the determined outcome. The system instructs the loyalty program provider to add any determined loyalty point awards to the loyalty point balance of the member.

In another embodiment, the system receives a request from a member of a loyalty program provided by a loyalty program provider to access a gaming user interface of the system and to use the gaming user interface to play one of a plurality of different games. The system receives a request from the member to play the requested game in one of one or more different play modes. The system determines and displays an entry fee associated with the requested game and the requested play mode. The entry fee includes a designated quantity of loyalty points. The system instructs the loyalty program provider to deduct the entry fee from a loyalty point balance of the member. The system displays a play of the requested game in the requested play mode, determines an outcome for the play, and determines any awards based on the determined outcome, wherein any determined awards in this embodiment do not include any loyalty points. The system causes any determined non-loyalty point awards to be provided to the member.

It should thus be appreciated that the system of the present disclosure solves the above-described problems by enabling members of a loyalty program to spend or wager their loyalty points in exchange for chances to win additional loyalty points or other awards through gaming while, over time, removing a steady stream of the spent or wagered loyalty points from circulation. The present disclosure thus contemplates adding an exciting and engaging element to loyalty programs and enabling loyalty program members to do what many already love to do—enjoy the thrill of gaming and win awards—while reducing the loyalty point liabilities on the loyalty program providers' balance sheets.

Additional features and advantages of the present disclosure are described in, and will be apparent from, the following Detailed Description and the Figures.

### BRIEF DESCRIPTION OF THE FIGURES

FIG. 1A illustrates an example of an embodiment of the loyalty point reduction system of the present disclosure that is associated with a single loyalty program provider.

FIG. 1B illustrates an example of an embodiment of the loyalty point reduction system of the present disclosure that is associated with multiple loyalty program providers.

FIG. 2 illustrates a flowchart of a process or method for operating an example embodiment of the loyalty point reduction system of the present disclosure.

FIGS. 3A, 3B, 3C, 3D, 3E, and 3F illustrate screen shots of an example loyalty program provider website and an example gaming UI of the loyalty point reduction system of the present disclosure.

FIG. 4A illustrates a screen shot of an example loyalty program provider website and an example gaming UI of the loyalty point reduction system of the present disclosure displaying an item shop.

FIG. 4B illustrates a screen shot of an example loyalty program provider website and an example gaming UI of the loyalty point reduction system of the present disclosure displaying a member's inventory.

FIG. 4C illustrates a screen shot of an example loyalty program provider website and an example gaming UI of the loyalty point reduction system of the present disclosure when the member clicks on or otherwise selects an add friend icon or button.

FIG. 4D illustrates a screen shot of an example loyalty program provider website and an example gaming UI of the loyalty point reduction system of the present disclosure when the member clicks on or otherwise selects a send gift icon or button.

FIG. 4E illustrates a screen shot of an example loyalty program provider website and an example gaming UI of the loyalty point reduction system of the present disclosure when the member clicks on or otherwise selects a friend's avatar.

### DETAILED DESCRIPTION

### Reducing Loyalty Point Liability Through Gaming

Various embodiments of the present disclosure are directed to a system and method for reducing loyalty point liability through gaming. Generally, the loyalty point reduction system (sometimes referred to herein as a “system” for brevity) enables a member of a loyalty program provided by a loyalty program provider to use the member's accumulated loyalty points to play one or more games, such as skill games or games of chance. The system enables the member to win loyalty points or other suitable awards (as described below) through play of the games. In various embodiments, the system employs one or more mechanisms to cause loyalty points to be removed from circulation; that is, the system causes loyalty point providers to remove loyalty points from members' loyalty point balances, thereby removing those loyalty points from the loyalty program providers' balance sheets. The system is configured such that, over time, more loyalty points are removed from circulation via these mechanisms than are added to circulation through awards provided to members through game play. It should thus be appreciated that the system of the present disclosure enables members of a loyalty program to spend or wager their loyalty points in exchange for a chance to win additional loyalty points or other awards and, over time, removes certain of the spent or wagered loyalty points from circulation as a fee for providing such a service.

### A. System Overview

In certain embodiments, the loyalty point reduction system is associated with a single loyalty program provider that provides loyalty points to members of its loyalty program. In these embodiments, the system of the present disclosure enables members who have accumulated balances of loyalty points associated with the single loyalty program provider to access a gaming user interface (UI) and play games using their accumulated loyalty points (as described in detail below).

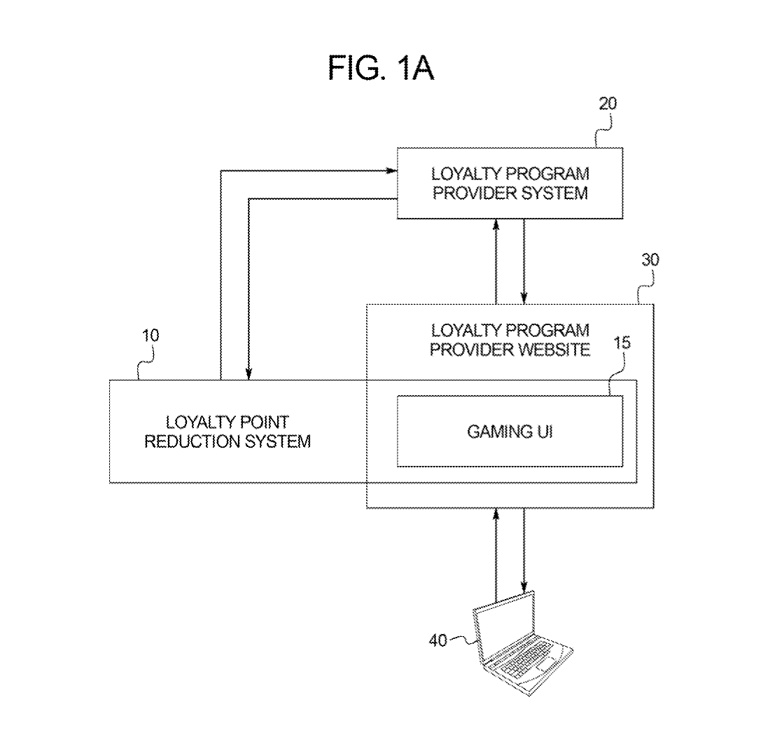

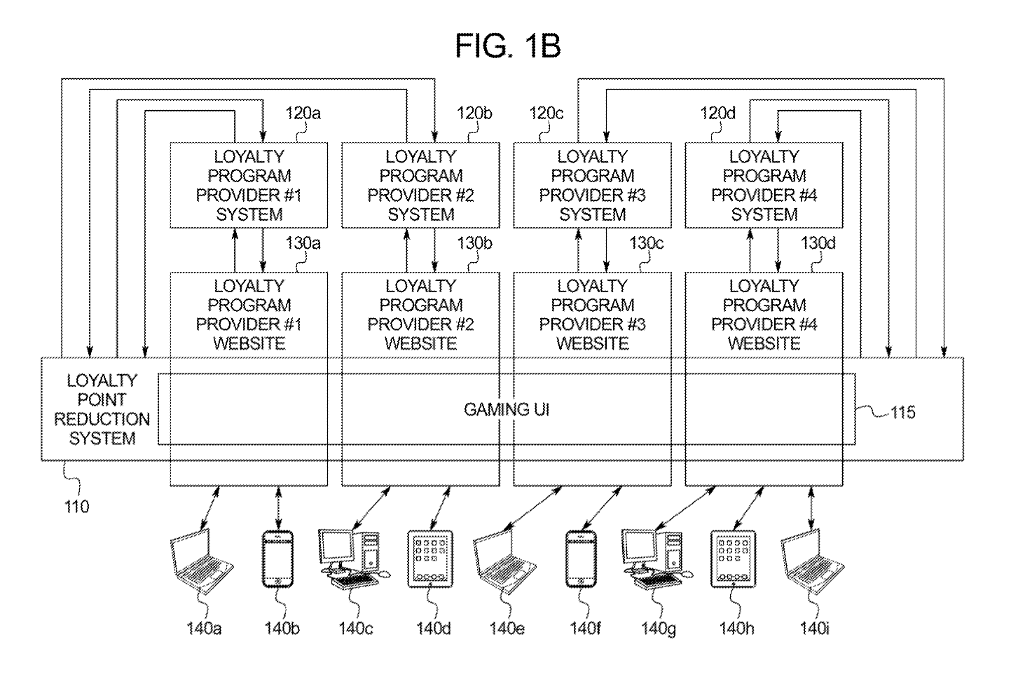

FIG. 1A illustrates an example of one such embodiment of the system of the present disclosure that is associated with a single loyalty program provider. In this example, loyalty point reduction system 10 is configured to communicate with a single loyalty program provider system 20. Loyalty point reduction system 10 and loyalty program provider system 20 each include one or more computing devices, such as one or more central servers, central controllers, or remote hosts, that include one or more central processing units and one or more memory devices. Loyalty program provider system 20 is configured to maintain and provide a loyalty program provider website 30 that is accessible by a member access device 40. Loyalty point reduction system 10 is configured to maintain and provide a gaming user interface (UI) 15 that is accessible via loyalty program provider website 30. Member access device 40 is configured to access gaming UI 15 via loyalty program provider website 30. The member access device includes one or more computing devices, such as one or more desktop computers, laptop computers, tablet computers, personal digital assistants (PDAs), mobile telephones such as smart phones, and other mobile computing devices. It should thus be appreciated that, in these embodiments, members having loyalty point balances associated with the single loyalty program provider may access the gaming UI using member access devices and use thesr accumulated loyalty points to play games.

In other embodiments, the loyalty point reduction system is associated with a plurality of different loyalty program providers that provide loyalty points to the members of their loyalty programs. In these embodiments, the system of the present disclosure enables members who have accumulated balances of loyalty points associated with one or more of the loyalty program providers to access a gaming UI and play games using their accumulated loyalty points (as described in detail below).

FIG. 18 illustrates an example of one such embodiment of the system of the present disclosure that is associated with multiple loyalty program providers. In this example, loyalty point reduction system 110 is configured to communicate with a plurality of different loyalty program provider systems 120a, 120b, 120c, and 120d. Loyalty point reduction system 110 and loyalty program provider systems 120a, 120b, 120c, and 120d each include one or more computing devices, such as one or more central servers, central controllers, or remote hosts, that include one or more central processing units and one or more memory devices. Loyalty program provider systems 120a, 120b, 120c, and 120d are each configured to maintain and provide a loyalty program provider website 130a, 130b, 130c, and 130d, respectively, that is accessible by one or more member devices, such as one of member devices 140a, 140b, 140c, 140d, 140e, 140f, 140g, 140h, and 140i. Loyalty point reduction system 110 is configured to maintain and provide a gaming UI 115 that is accessible via loyalty program provider websites 130a, 130b, 130c, and 130d. The member access devices are configured to access gaming UI 115 via loyalty program provider websites 130a, 130b, 130c, and 130d. It should thus be appreciated that, in these embodiments, members having loyalty point balances associated with different loyalty program providers may access the gaming UI using member access devices and use their accumulated loyalty points to play games.

In certain embodiments, such as those described above with respect to FIGS. 1A and 1B, the member access device is configured to access the gaming UI via the loyalty program provider website of the loyalty program provider system. In one example of such an embodiment, to do so, the member opens a web browser on the member's desktop computer (i.e., the member's member access device), navigates to the loyalty program provider website using the web browser, and accesses the gaming UI by selecting a designated icon, button, or hyperlink on the loyalty program provider website.

In other embodiments, the loyalty point reduction system is configured to maintain and provide the gaming UI via a loyalty point reduction system website that is separate from any loyalty program provider website. In one example, the member opens a web browser on the member's laptop computer (i.e., the member's member access device), navigates to the loyalty point reduction system website, and accesses the gaming UI using the loyalty point reduction system website. Thus, in these embodiments, the member is not required to navigate to any loyalty program provider website to access the gaming UI and play games using the member's loyalty points. In one embodiment, the loyalty point reduction system website enables a member to “link” multiple loyalty program accounts together and play games at a multi-loyalty program website using the gaming UI.

In further embodiments, the member access device is configured to access the gaming UI via one or more applications (commonly referred to as “apps”) downloaded to the member access device. In one example, the member opens or launches an application on the member's tablet computing device or smart phone (i.e., the member's member access device), and the application provides the member access to the gaming UI. Thus, in these embodiments, the member is not required to navigate to any loyalty program provider website or any loyalty point reduction system website to access the gaming UI and play games using the member's loyalty points. In one embodiment, the system enables a member to pay a designated quantity of loyalty points to purchase a “premium” or “upgraded” application that includes additional features or functionality.

It should be appreciated that, in various embodiments, the system of the present disclosure is configured to enable members to use member access devices to access the gaming UI through the internet or any other suitable data network, such as a mobile communications network, to play games using loyalty points.

When a member access device accesses the gaming UI of the loyalty point reduction system via a website, the system causes the member access device to display certain images and/or information to the member, and enables the member to make certain inputs using one or more input devices of the member access device. Similarly, if the loyalty point reduction system is implemented in whole or in part through an application downloaded to the member access device, the application, when opened or launched, causes the member access device to display certain images and/or information to the member, and enables the member to make certain inputs using one or more input devices of the member access device.

For brevity, throughout this application, instead of stating that the system of the present disclosure (or an application thereof) causes the member access device to display images and/or information to the member, the present application often simply states or explains this by stating that the system displays images and/or information to the member. Similarly, for brevity, instead of stating that the system of the present disclosure (or application thereof) causes the member access device to enable the member to make inputs, the present application often states or explains this by stating that the system enables the member to make inputs. It should be appreciated that such statements are for brevity and not meant to limit the scope of the present disclosure.

### B. Example Method of Operating the System

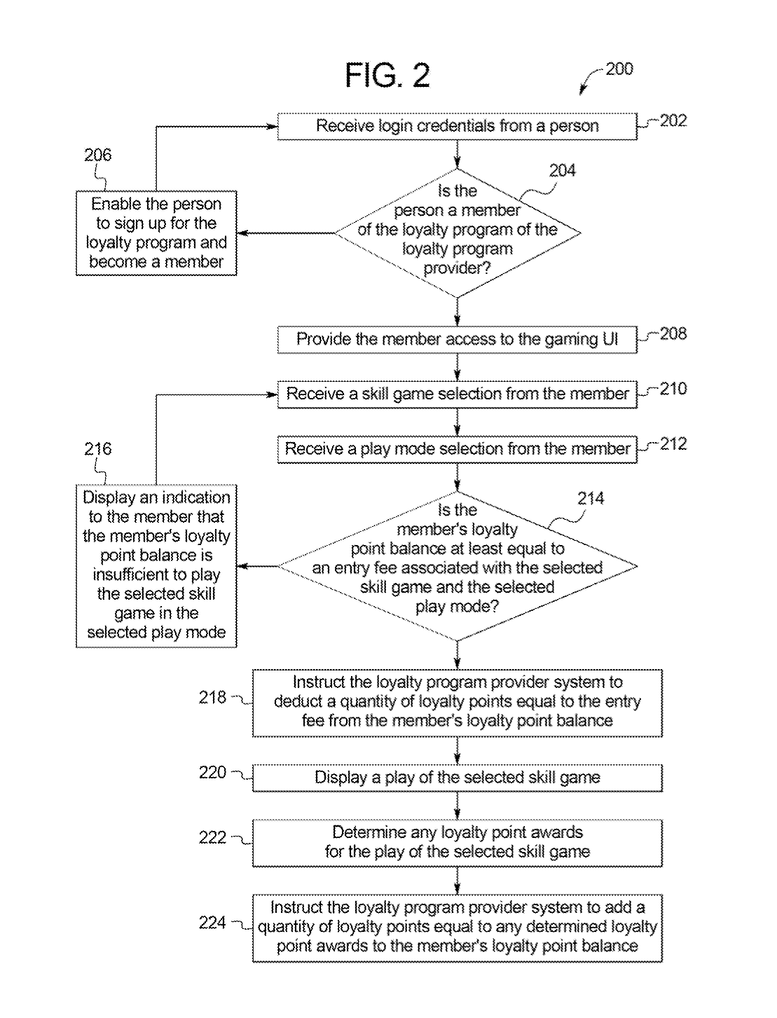

FIG. 2 illustrates a flowchart of a process or method 200 for operating an example embodiment of the loyalty point reduction system of the present disclosure. In various embodiments, process 200 is represented by a set of instructions stored in one or more memories and executed by one or more processors. Although process 200 is described with reference to the flowchart shown in FIG. 2, it should be appreciated that many other processes of performing the acts associated with this illustrated process may be employed. For example, the order of certain of the illustrated blocks and/or diamonds may be changed, certain of the illustrated blocks and/or diamonds may be optional, and/or certain of the illustrated blocks and/or diamonds may not be employed.

As noted above, the loyalty point reduction system of the present disclosure enables a member of a loyalty program provided by a loyalty program provider associated with the system to use the member's accumulated loyalty points to play games using the gaming UI. Accordingly, before enabling a person to access the gaming UI and begin playing games using loyalty points, the loyalty point reduction system of the present disclosure authorizes the person to do so by first determining whether that person is a member of the loyalty program.

In this example, the loyalty point reduction system receives login credentials (in this example, a username and password) from a person, as indicated by block 202. The loyalty point reduction system determines if the person is a member of the loyalty program provided by the loyalty program provider associated with the loyalty point reduction system, as indicated by diamond 204. In this example, the loyalty point reduction system does so by determining whether the login credentials match an entry in a database stored by the loyalty point reduction system that includes the login credentials of all of the members of the loyalty program associated with the loyalty point reduction system. In another embodiment the loyalty point reduction system does so by transmitting data representing the received login credentials to the loyalty program provider system, which in turn determines whether those login credentials match an entry in a database (as described above) stored by the loyalty program provider system and indicates to the loyalty point reduction system whether the person is a member of the loyalty program. In a further embodiment, the loyalty point reduction system does so by receiving “pass-through” authentication from the loyalty program provider system. That is, in this embodiment, the loyalty program provider system indicates to the loyalty point reduction system that the person has already been authenticated as a member of the loyalty program (such as through a login process on the loyalty program provider website). In other embodiments, the loyalty point reduction system receives the member's login credentials from a social networking site of which the member is a member, a mobile device of the member, and/or another third-party provider. It should be appreciated that such authentication may be performed in any suitable manner.

Returning to FIG. 2, if the loyalty point redaction system determines that the person is not a member of the loyalty program, in this example the loyalty point reduction system enables the person to sign up for the loyalty program and, therefore, become a member, as indicated by block 206. Process 200 then returns to block 202. If, on the other hand, the loyalty point reduction system determines that the person is a member of the loyalty program, the loyalty point reduction system provides the member access to the gaming UI, as indicated by block 208, thus enabling the member to use the member's loyalty points to play one or more games or to perform other tasks (described below). The loyalty point reduction system receives a selection of a skill game from the member that the member desires to play, as indicated by block 210. The loyalty point reduction system receives a selection of a play mode from the member in which the member wishes to play the selected skill game, as indicated by block 212.

In this example, the loyalty point reduction system determines whether the member's loyalty point balance is at least equal to an entry fee associated with the selected skill game and the selected play mode, as indicated by diamond 214. The loyalty point reduction system does so by requesting (and, in turn, receiving) the member's loyalty point balance from the loyalty program provider system. If the loyalty point reduction system determines that the member's loyalty point balance is less than the entry fee associated with the selected skill game and the selected play mode, the loyalty point reduction system displays an indication to the member that the member's loyalty point balance is insufficient to play the selected skill game in the selected play mode, as indicated by block 216. Process 200 then returns to block 210.

If instead the loyalty point reduction system determines that the member's loyalty point balance at least equals the entry fee associated with the selected skill game and the selected play mode, the loyalty point reduction system instructs the loyalty program provider system to deduct a quantify of loyalty points equal to the entry fee from the member's loyalty point balance, as indicated by block 218. The loyalty point reduction system displays a play of the selected skill game, as indicated by block 220. In this example, the loyalty point reduction system enables the member to win loyalty points as an award for the play of the selected skill game, though if should be appreciated that, in other embodiments, the system does not enable the member to win loyalty points as an award for any play of any game. Thus, the loyalty point reduction system determines any loyalty point awards for the play of the selected skill game, as indicated by block 222. The loyalty point reduction system instructs the loyalty program provider system to add a quantity of loyalty points equal to any determined loyalty point awards to the member's loyalty point balance, as indicated by block 224.

### C. The Gaming UI

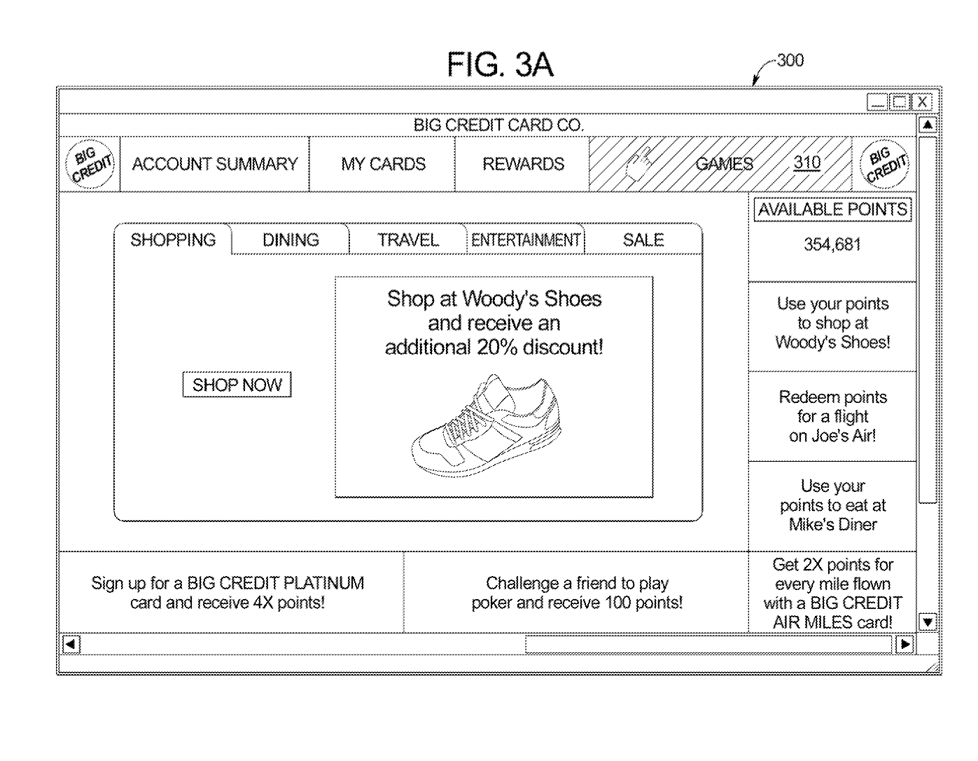

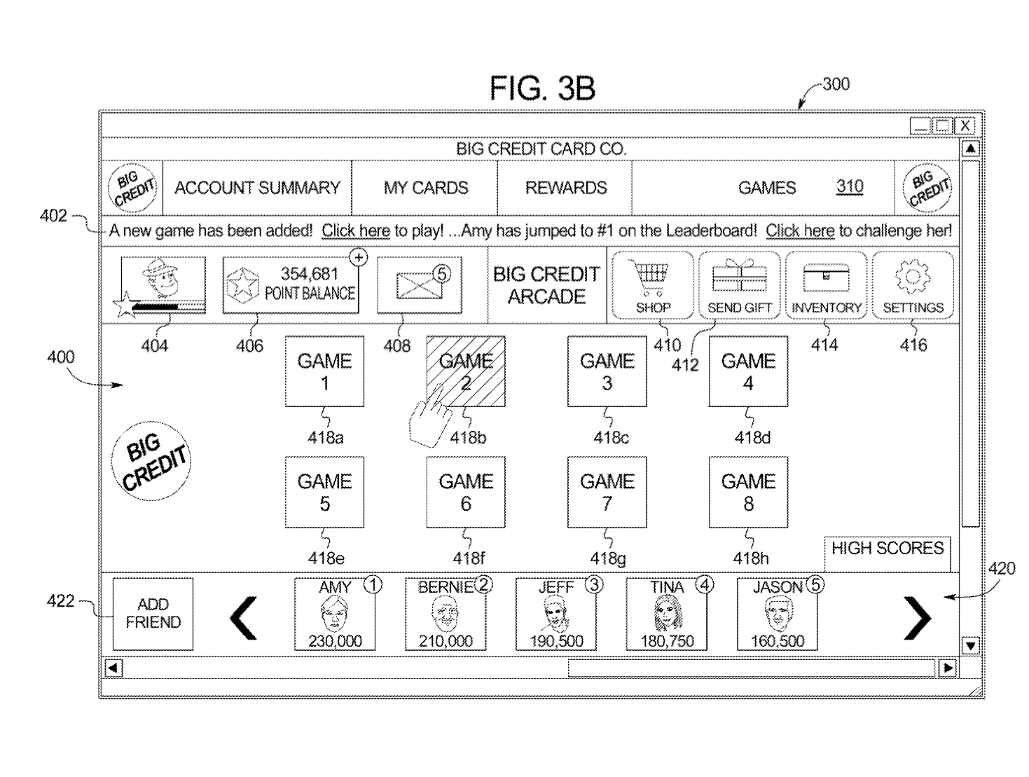

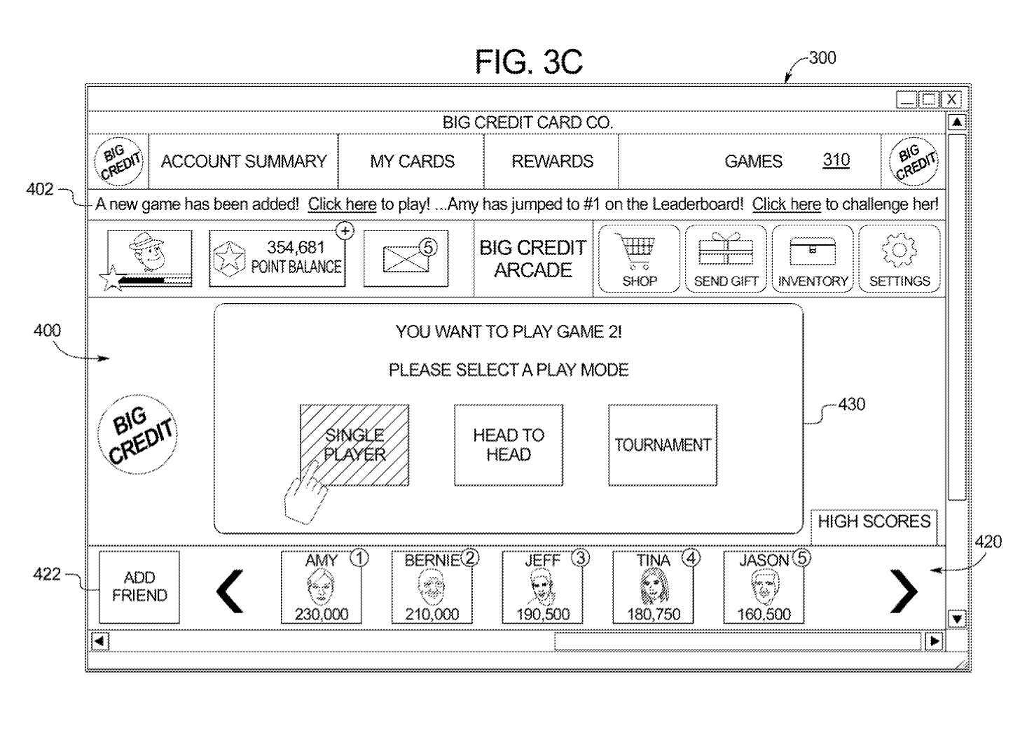

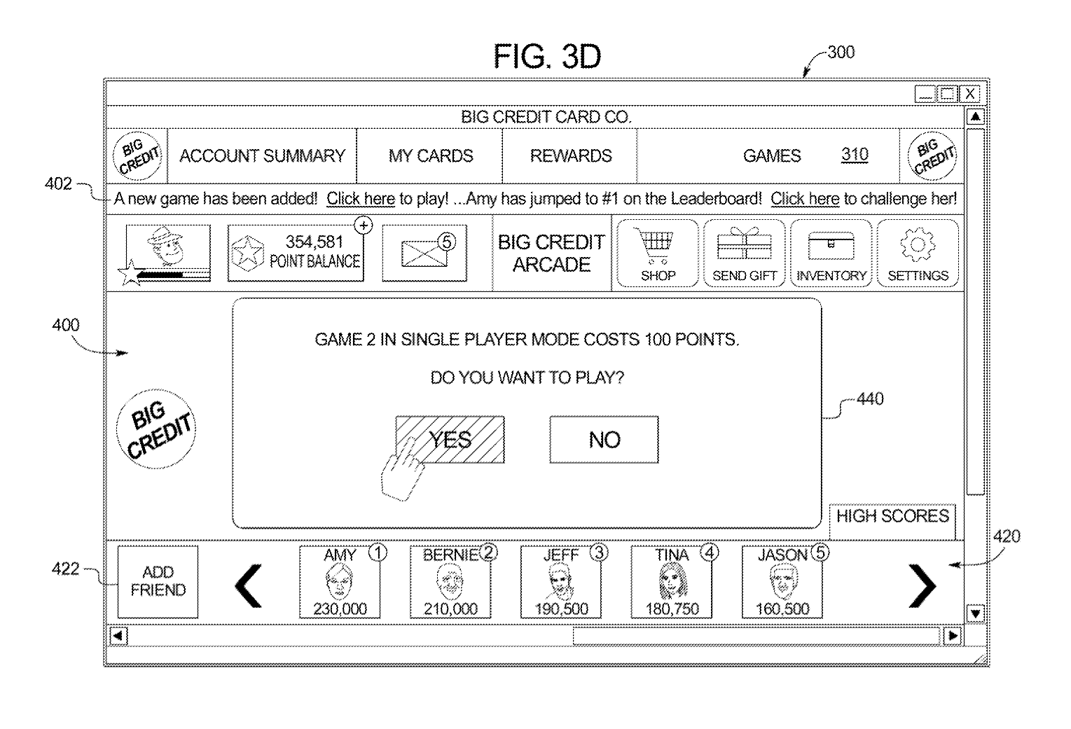

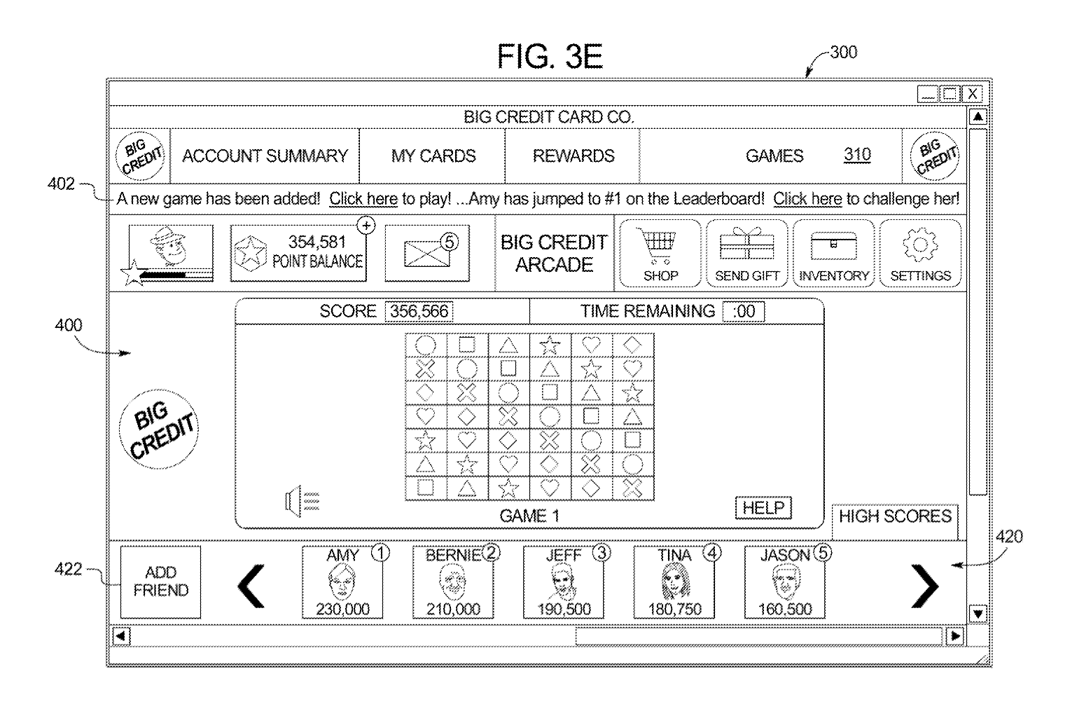

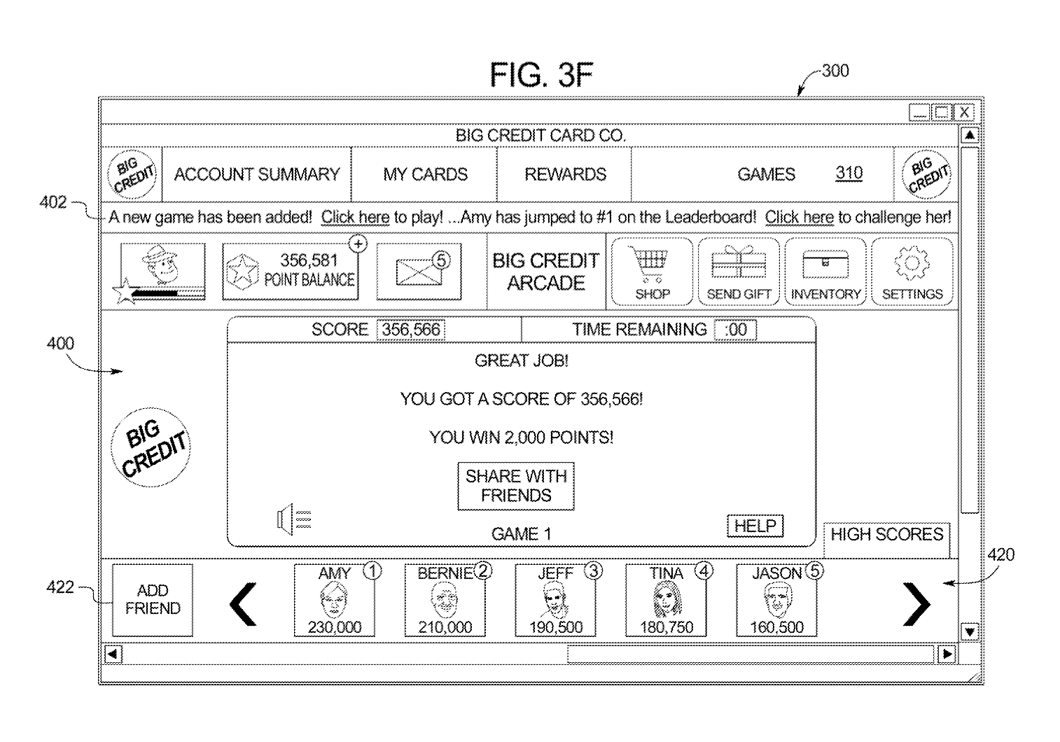

As noted above, the loyalty point reduction system maintains and enables members to access a gaming UI through which members may use their loyalty points to play games. FIGS. 3A, 3B, 3C, 3D, 3E, and 3F illustrate screen shots of an example loyalty program provider website and an example gaming UI of the loyalty point reduction system of the present disclosure. In this example, a person uses a member access device to access the gaming UI via the loyalty program provider website of the loyalty program provider system, as described below. This example demonstrates certain basic or fundamental functions or features of various embodiments of the loyalty point reduction system of the present disclosure. It should be appreciated, however, that commercial implementations of the loyalty point reduction system of the present disclosure will likely include substantial additional functionality or features, and that this example website and gaming UI are not being used to fully demonstrate a commercial embodiment of the loyalty point reduction system.

In this example, a member access device (not shown) enables a person to access the gaming UI through a loyalty program provider website 300, as generally illustrated in FIG. 3A. After the person has indicated a desire to access the gaming UI, such as by clicking on or otherwise selecting a designated button, icon, or hyperlink 310, the loyalty point reduction system (or the loyalty program provider system, in certain embodiments), authenticates the person as a member of the loyalty program. After the person has been authenticated as a member, the loyalty point reduction system enables the member to access the gaming UI 400 shown in FIG. 3B. It should be appreciated from FIGS. 3A and 3B (and from various other Figures) that the loyalty program provider website and the gaming UI may include conventional website tabs, buttons, or links such as, but not limited to: (1) an “About Us” link (not shown); (2) a “Help” link (not shown); (3) a “Become a Member” link (not shown); and (4) a “Contact Us” link (not shown). These links direct the member to more functionality of the loyalty point reduction system and/or the gaming UI, which is of a conventional nature, though it should be appreciated that the loyalty program provider website and/or the gaming UI need not include such functions. It should also be appreciated that the loyalty program provider website and/or the gaming UI can provide various other functions, such as advertisements, and will likely include the loyalty program provider's name and logos.

As shown in FIG. 3A, in this example a person selected the designated icon 310 to access the gaming UI. In this example, the loyalty point reduction system authenticated the person as a member of the loyalty program (not shown), and enabled the member to access gaming UI 400. FIG. 3B illustrates gaming UI 400 operated within loyalty program provider website 300. As should be appreciated from FIG. 3B, gaming UI 400 provides a variety of information and options to the member. Specifically, in this example, gaming UI 400 includes: (a) a scrolling information banner that displays information about new games, the member's friends scores, new purchasable upgrades or items, offers to redeem loyalty points, promotions, and any other suitable information to the member; (b) a member avatar 404; (c) the member's loyalty point balance 406; (d) a selectable notification icon or button 408 that, when selected, displays certain notifications to the member, such as challenges presented from friends of the member, messages sent to the member, or gifts given to the member; (e) a selectable shopping icon or button 410 that, when selected, enables the member to purchase one or more items or services (as described below); (f) a selectable send gift icon or button 412 that, when selected, enables the member to send a gift to a friend of the member (as described below); (g) a selectable inventory icon or button 414 that, when selected, causes the system to display any item the member has won or earned, has been gifted by another member, or has purchased; (h) a selectable settings icon 416 that, when selected, enables the member to modify or view one or more settings of the gaming UI; (i) a plurality of selectable game icons 418a, 418b, 418c, 418d, 418e, 418f, 418g, and 418h each associated with a different game that, when selected, cause the system to initiate a play of the associated game for the member; (j) a leaderboard 420 that displays the high scores for one or more games for certain of the member's friends (as described below); and (k) a selectable add friend icon or button 422 that, when selected, enables the member to invite one or more friends to join the loyalty program or participate in the system via the gaming UI (as described below).

As shown in FIG. 3B, the member selected button 418b, which is associated with Game 2. As illustrated in FIG. 3C, in this example the system displayed a pop-up window 430 and instructed the member to select the play mode in which the member desired to play Game 2. In this instance, the member selected the Single Player play mode. As shown in FIG. 30, the system displayed another pop-up window 440 informing the member that the member must pay an entry fee of 100 loyalty points to play Game 2 in the Single Player play mode, and asked the member to confirm that the member desired to play. The member confirmed that the member desired to pay 100 loyalty points to play Game 2 in the Single Player play mode and, accordingly, the system instructed the loyalty program provider system to deduct 100 loyalty points from the member's loyalty point balance.

As illustrated in FIG. 3E, the loyalty point reduction system displayed Game 2 to the member, and enabled the member to play Game 2 in the Single Play mode. As shown in FIG. 3E, which illustrates Game 2 upon its completion, the member earned a score of 358,568 for the play of Game 2. In this example, as shown in FIG. 3F, the loyalty point reduction system determined an award of 2,000 loyalty points for the member for achieving a score of 358,566. Accordingly, the loyalty point reduction system instructed the loyalty program provider system to add 2,000 loyalty points to the member's loyalty point balance.

It should be appreciated that, in other embodiments, the loyalty point reduction system enables the member to access the gaming UI in by clicking on or otherwise selecting a designated button, icon, or hyperlink located in: (a) a dropdown box accessible via the loyalty program provider website, (b) a “featured item” banner on the loyalty program provider's website, (c) an advertising banner on the loyalty program provider's website (such as a banner along the bottom or the side of the website), (d) a “rewards” section or page of the loyalty program provider's website, (e) the member's account summary page on the loyalty program provider's website, (f) a pop-up window, (g) a promotional email, (h) a promotional instant message, (i) a promotional text message, (j) a promotional message sent through a social networking site or posted on the member's social network feed, (k) an application installed on the member's member access device (such as on the member's smart phone or tablet computer), (l) a micro-site; and/or (m) a loyalty point reduction system website (such as any of those described above).

D. Quantity of Loyalty Program Providers Associated with the System

As noted above, in certain embodiments, the loyalty point reduction system is associated with a single loyalty program provider. In these embodiments, the system enables members who have accumulated balances of loyalty points associated with the single loyalty program provider to play games using their accumulated loyalty points. In other embodiments, the system is associated with a plurality of different loyalty program providers that provide loyalty points to the members of their loyalty programs. In these embodiments, the system enables members who have accumulated balances of loyalty points associated with one or more of the loyalty program providers to play games using their accumulated loyalty points (as described in detail below).

1. Single Loyalty Program Provider Associated with the Reduction System

In these embodiments, the loyalty point reduction system is associated with a single loyalty program. That is, the system is configured such that only members of that single loyalty program who have accumulated a balance of loyalty points may access the system's gaming UI and use their loyalty points to play games using the gaming UI. For instance, Big Airline offers a loyalty program in which members earn Big Airline Miles, and Big Credit Card Co. offers a loyalty program in which members earn Big Credit Card Points. Big Airline's loyalty program is associated with the loyalty point reduction system, and Big Credit Card Co.'s loyalty program is not. Thus, in this example, members of the Big Airline loyalty program may access the gaming UI of the system and use their Big Airline Miles to play games, and members of the Big Credit Card Co. loyalty program who are not members of Big Airline's loyalty program may not.

2. Multiple Loyalty Program Providers Associated with the System

In these embodiments, the loyalty point reduction system is configured to manage different types of loyalty points across a plurality of different loyalty programs. In other words, in these embodiments, the system is configured such that members of different loyalty programs who have accumulated balances of different types of loyalty points may access the same gaming UI of the same system (though it may appear different to different members, as explained below) and use their loyalty points to play games using the gaming UI. For Instance, Big Airline offers a loyalty program in which members earn Big Airline Miles, and Big Credit Card Co. offers a loyalty program in which members earn Big Credit Card Points. In this example, members of the Big Airline loyalty program and members of the Big Credit Card Co. loyalty program access the same gaming UI of the same loyalty point reduction system even though the members have different types of loyalty points (i.e., Big Airline Miles and Big Credit Card Points in this example). In certain such embodiments, the system is configured to enable a single member of a plurality of different loyalty programs to access the gaming UI and play games using loyalty points associated with the plurality of different loyalty programs.

To account for the different types of loyalty points of the different loyalty point providers associated with the loyalty point reduction system, the system employs a separate exchange rate for each loyalty program that equates a loyalty point of that loyalty program to a baseline value, such as a value in United States dollars (USD). The system stores all entry fees, prize amounts, prices, etc. as USD values. When a member accesses the gaming UI of the system, the system determines which loyalty program the member is affiliated with. The system uses the exchange rate associated with that loyalty program to convert all entry fees, prize amounts, prices, etc. from their USD values to their values in terms of loyalty points of that loyalty program. Thus, the system displays such entry fees, prize amounts, prices, etc. to that individual member in terms of the specific loyalty points of the loyalty program that that individual member is a part of.

In one example, the system values Big Airline Miles at $0.10 per mile and Big Credit Card Points at $0.20 per mile. John is a member of the Big Airline loyalty program, and Jane is a member of the Big Credit Card Co. loyalty program. John logs into the gaming UI of the system, and the system displays a tournament having an entry fee of 10 Big Airline Miles (which have a value of $1). Jane also logs into the gaming UI of the system, and the system displays that same tournament, but having an entry fee of 5 Big Credit Card Points (which also have a value of $1). Thus, although John and Jane have to pay different quantities of their respective loyalty points to participate in the tournament, the values of those different quantities of loyalty points are equivalent.

Continuing with the above example, John uses the gaming UI to send a head-to-head challenge to Jane using the gaming UI of the system, choosing a wager amount of 20 Big Airline Miles (which have a value of $2). Jane receives the challenge, and the system indicates that it would cost Jane 10 Big Credit Card Points (which also have a value of $2) to accept the head-to-head challenge against John. Thus, although John and Jane have to pay different quantities of their respective loyalty points to participate in the head-to-head challenge, the values of those different quantities of loyalty points are equivalent. If Jane accepts John's challenge, the system deducts a 25% service fee from the combined entry fees, and the remainder forms an award pool. The system displays the award pool to John as 30 Big Airline Miles (which have a value of $3) and to Jane as 15 Big Credit Card Points (which also have a value of $3). Thus. although John and Jane would receive different quantities of their respective loyalty points should he or she win the head-to-head challenge, the values of those different quantities are equivalent.

Continuing with the above example, John visits the shop using the gaming UI of the system and decides to purchase a Golden Key item that the system displays as having a price of 50 Big Airline Miles (which have a value of $5). Jane visits the shop using the gaming UI of the system and decides to purchase the same Golden Key item that the system displays as having a price of 25 Big Credit Card Co. Points (which also have a value of $5). Thus, although John and Jane pay different quantities of their respective loyalty points to purchase the same item, the values of those different quantities of loyalty points are equivalent.

It should be appreciated that the gaming UI differs for members of different loyalty programs. For example, the experience of a member of Big Airline's loyalty program in the gaming UI is different than the experience of a member of Big Credit Card Co.'s loyalty program in the gaming UI. One difference, explained above, is that for each member the system displays entry fees, prize amounts, prices, and the like to that member in terms of the loyalty points of the loyalty program that that individual member is a part of.

Another difference is that the system displays different graphical appearances, commonly referred to as “skins,” for members of different loyalty programs. For example, for members of Big Airline's loyalty program, the system employs a skin that is tailored to Big Airline. Such a skin may include a color scheme that matches Big Airline's color scheme, advertisements or promotions offered by Big Airline or its affiliates, Big Airline's logos and/or trademarks, airline-themed symbols and game art, airline-themed games or purchasable items, and airline-themed music or sound effects. On the other hand, for members of Big Credit Card Co.'s loyalty program, the system employs a skin that is tailored to Big Credit Card Co. Such a skin may include a color scheme that matches Big Credit Card Co.'s color scheme, advertisements or promotions offered by Big Credit Card Co. or its affiliates, Big Credit Card Co.'s logos and/or trademarks, credit card-themed symbols and game art, credit card-themed games or purchasable items, and music or sound effects associated with Big Credit Card Co.

E. Removing Loyalty Points from Circulation Through Gaming

As generally noted above, the loyalty point reduction system is configured such that, over time, more loyalty points are removed from circulation via these mechanisms than are added to circulation through loyalty point awards (if any) provided to members through game play.

In various embodiments, the system requires a member to pay an entry fee of a quantity of loyalty points to play a game. When the system receives an input indicating that the member wishes to pay the entry fee, the system instructs the loyalty program provider system to deduct that entry fee (i.e., deduct the quantity of loyalty points included in the entry fee) from the member's loyalty point balance, thereby causing those loyalty points to be removed from circulation and reducing the loyalty point liability on the loyalty program provider's balance sheet. It should be appreciated that, in certain such embodiments, the system configures the paytables for games including such entry fees such that, on average, more loyalty points are removed from circulation than are added to circulation through loyalty point awards (if any) provided to members, thereby causing a steady stream of loyalty points to be removed from circulation and from the loyalty program providers' balance sheets.

In other embodiments, the system requires a member to pay an entry fee of a quantity of loyalty points to enter a tournament. When the system receives an input indicating that the member wishes to pay the entry fee to join the tournament, the system instructs the loyalty program provider system to deduct that entry fee (i.e., deduct the quantity of loyalty points included in the entry fee) from the member's loyalty point balance, thereby causing those loyalty points to be removed from circulation and reducing the loyalty point liability on the loyalty program provider's balance sheet. The system then deducts a service fee from that entry fee and adds the remaining portion of that entry fee to an award pool that is provided to tournament winners. It should thus be appreciated that, in such embodiments, more loyalty points are removed from circulation (via the entry fees) than are added to circulation via the award pool of loyalty points (which includes the entry fees after a service fee has been applied). Thus, regardless of which member(s) wins the tournament, each completed tournament results in a net quantity of loyalty points being removed from circulation and, therefore, from loyalty program providers' balance sheets, due to the service fee.

In certain embodiments, the system requires a member to place a wager of at least a minimum quantity of loyalty points to play a game of chance. When the system receives an input indicating a wager the member desires to place on a game of chance, the system instructs the loyalty program provider system to deduct that wager (i.e., deduct the quantity of loyalty points included in the wager) from the member's loyalty point balance, thereby causing those loyalty points to be removed from circulation and reducing the loyalty point liability on the loyalty program provider's balance sheet. The system then displays a play of the game of chance and determines and provides any awards for the play of the game of chance. It should be appreciated that, in certain such embodiments, the system configures the games of chance such that their average expected payback percentages are less than 100% (i.e., such that their average expected holds are greater than 0%). This ensures that, over time, more loyalty points are removed from circulation (via wagers) than are added to circulation through loyalty point awards (if any) provided to members, thereby causing a steady stream of loyalty points to be removed from circulation and from the loyalty program providers' balance sheets.

In various embodiments, the system enables members to play table games such as poker games among one another, and employs a rake or vigorish for such games. In one example, the system enables members to play a Texas Hold'em game against one another. In this example, the system enables members to place wagers of loyalty points into a pot for a play of the Texas Hold'em game. The system provides the pot to the winning member upon completion of the play. When the system receives an input indicating a wager a member desires to place for a play of the Texas Hold'em game, the system instructs the loyalty program provider system to deduct that wager (i.e., deduct the quantity of loyalty points included in the wager) from the member's loyalty point balance, thereby causing those loyalty points to be removed from circulation and reducing the loyalty point liability on the loyalty program provider's balance sheet. The system then adds the member's wager to the pot for the play of the game. In this example, the system retains a rake of a designated percentage (such as 5% or 10%) of each final pot of each play, and removes the retained loyalty points from circulation. Thus, regardless of which member(s) wins the final pot, each completed play results in a net quantity of loyalty points being removed from circulation and, therefore, from loyalty program providers' balance sheets, due to the rake.

In other embodiments in which loyalty point awards are provided to members for plays of games, the system deducts or retains a service fee from each award. That is, in such embodiments, when the system determines a loyalty point award for a member for a play of a game, the system deducts a designated amount from or a designated percentage of that loyalty point award before providing it to the member. Thus, in these embodiments, the system reduces how many loyalty points are provided to members via awards, thereby reducing the number of loyalty points added to circulation (and to the loyalty program providers' balance sheets).

In certain embodiments, the system enables members to use their loyalty points to purchase game upgrades or customizable features. In one example, the system enables members to pay a designated quantity of loyalty points to receive a better paytable for a play of a game. In another example, the system enables members to pay a designated quantity of loyalty points to receive a different volatility for a play of a game. In a further example, the system enables members to pay a designated quantity of loyalty points to become eligible for certain awards (such as jackpot awards or progressive awards) for a play of a game. In one example, the system enables members to pay a designated quantity of loyalty points to activate loyalty point awards for a play of a game. In another example, the system enables members to pay a designated quantity of loyalty points to become eligible to win plays of bonus games for a play of a game.

In various embodiments, the system enables members to use loyalty points to purchase: (a) new games, (b) new levels in existing games, (c) gifts to send to friends (described below), (d) upgrades to their avatars or their gaming UI skin or interface, (a) VIP access, (f) new missions (described below), and/or (g) any suitable new content or additional features. In such embodiments, when a member purchases such new content or a new feature using a quantity of loyalty points, the system instructs the loyalty program provider system to remove those loyalty points from the member's loyalty point balance, thereby causing loyalty points to be removed from circulation (and from the loyalty point provider's balance sheet).

It should be appreciated that any suitable manner of causing loyalty points to be removed from circulation may be employed in addition to, in conjunction with, or instead of the examples described above.

### F. Types of Games

1. Games of Skill

In various embodiments, the loyalty point reduction system enables members to play skill games that reward more skilled members than less skilled members or pseudo-skill games that appear to involve skill elements. In one embodiment, the system requires a member to pay an entry fee of a quantity of loyalty points to play a skill game. In this embodiment the system instructs the loyalty program provider system to remove the loyalty points included in the entry fee from the member's loyalty point balance, and enables the member to play the skill game. The system rewards the member if the member meets one or more conditions during play of the skill game, such as by achieving a certain level, reaching a certain score, completing a certain mission or task, collecting a certain number of items, or finishing in a certain position in a race. It should be appreciated that, in certain embodiments, the system determines any awards for a play of a skill game based at least in part on the skill of the member playing the skill game.

It should be appreciated that the system may enable members to play any suitable skill games, such as: racing games in which the member races a vehicle (such as a car or a boat); target shooting games in which the member must shoot one or more targets; puzzle games in which the member must complete one or more puzzles; sports games in which the member competes in a sporting event; games that involve mental skill, knowledge, logical deduction or strategy; hidden object or search games; word and trivia games; card games; physics games (such as a game in which the member optimizes the use of physics to achieve a goal, like tossing an object a maximum distance); arcade games; strategy games (such as time and/or resource management games); and/or dexterity-based games.

2. Games of Chance

In certain embodiments, the loyalty point reduction system enables members to play games of chance in which the member wagers the member's loyalty points on one or more plays of the games of chance. In one such embodiment, the system requires a member to place a wager of at least a minimum quantity of loyalty points on a play of the game of chance, and instructs the loyalty program provider system to reduce the members loyalty point balance by the wagered quantify. In this embodiment, the game of chance is a slot game having an average expected payback percentage of 95% and an average expected hold of 5%. Thus, on average, the system pays back 95% of the members' loyalty point wagers and retains (and removes from circulation), on average, the remaining 5% of the members' loyalty point wagers.

It should be appreciated that the system determines any outcomes and awards for a play of a game of chance in any suitable manner, such as any of those described below. It should also be appreciated that the system may enable members to play any suitable games of chance, such as: slot or spinning reel games; card games such as blackjack games, poker games, and baccarat games; roulette games; keno games; and selection games.

### G. Awards

1. Awards for Game Outcomes

It should be appreciated that the loyalty point reduction system may provide any suitable awards to a member for that member achieving a winning outcome or outcomes for a play of a game. In one embodiment, the system provides awards that include loyalty points. In another embodiment, the system provides awards that do not Include loyalty points, and thus does not introduce additional loyalty points into circulation (and onto the loyalty point provider's balance sheet). For instance, in various embodiments, the system provides one or more of the following non-loyalty point awards: (a) a multiplier for use in one or more future plays or one or more games; (b) one or more free plays of one or more games; (c) a designated quantify of virtual currency other than loyalty points; (d) one or more plays of one or more secondary or bonus games; (e) one or more lottery based awards, such as lottery or drawing tickets; (f) a wager match for one or more plays of one or more games; (g) an increase in the average expected payback percentage of one or more games of chance for one or more plays of those games; (h) one or more awards having monetary value, such as a free dinner, a free night's stay at a hotel, a free flight, a free car rental, ma high value product such as a free car, or a low value product such as a free teddy bear; (i) one or more vanity items (such as a “lucky charm” or an accessory for an avatar, as described below); (j) an increase in a membership level or tier; (k) coupons, promotions, or special offers (e.g., a 20% off coupon for use at an affiliate of the loyalty provider or a special offer that enables the member to redeem the member's loyalty points for double their value); (l) an access code usable to unlock certain unlockable content; (m) one or more virtual items; (n) a gift card or a cash award; and/or (o) a more beneficial volatility for a game (i.e., a paytable including a jackpot or other large award).

2. Achievement Awards

In certain embodiments, the system enables members to earn achievement awards for reaching certain milestones, completing certain missions or activities, or satisfying certain conditions associated with game play. It should be appreciated that the achievement awards may be any of the awards listed above.

In certain embodiments, the system provides a member with or enables the member to complete one or more missions. In these embodiments, if the member completes the mission, the system provides the member with an achievement award. To complete the missions, in one embodiment the member must complete a set of one or more tasks or goals. In one example, the system provides a member with a mission to set a high score for a certain game within one hour. If the member does so, the system provides the member with an achievement award of a multiplier active for the next ten plays of that game for which the member obtained the high score to complete the mission.

In another example, the system provides the member with a mission to collect a set or collection of certain virtual items by playing games to win the virtual items, purchasing the virtual items, or receiving the virtual items as gifts. When the member completes the mission by collecting all of the virtual items of the set, in this example the system provides the member with a rare “lucky charm” virtual item (described below) as an achievement award. In another example, the system provides the member with a virtual badge, ribbon, or trophy signifying that the member has completed the mission. The system displays such achievement awards in a virtual award or trophy case associated with the member. In certain embodiments, the system provides the member an achievement award when the member collects a certain number of virtual badges, ribbons, or trophies or completes a certain set of virtual badges, ribbons, or trophies.

In another embodiment, the system provides a member with experience points for various actions the member takes within the arcade, such as playing games, achieving high scores, inviting friends, and purchasing items. The system assigns the member an experience level based on the quantity of experience points accumulated by the member. In this embodiment, the system provides the member an achievement award of a free game play when the member reaches certain experience levels (such as each time the member's experience level increases).

### H. Play Modes

1. Tournament Play

In certain embodiments, the loyalty point reduction system enables members to play games against one another in a tournament setting. In one embodiment, the system requires each member who desires to participate in a tournament to pay an entry fee of a quantity of loyalty points. In this embodiment, the system pools all of the entry fees together, retains a portion of those pooled loyalty points as a service fee and removes the retained loyalty points from circulation (as described above), and creates an award pool including the remaining loyalty points. The service fee may be, for example, a designated percentage of the loyalty points of the pooled entry fees or a designated amount of the loyalty points of the pooled entry fees. In one embodiment, the system conducts the tournament and provides the loyalty points of the award pool as awards for the tournament.

In one example, Mike is a member of Big Airline's loyalty program, and has accumulated a balance of 50,000 Big Airline Miles. Mike uses his member access device to access Big Airline's website, and accesses the loyalty point reduction system by clicking on a designated icon on Big Airline's website. Mike identifies himself to the system by logging in with his unique username and password. After logging in, Mike joins a tournament having an entry fee of 10 Big Airline Miles. The system instructs Big Airline to deduct 10 Big Airline Miles from Mike's Big Airline Mile balance so that, after paying the entry fee, Mike's Big Airline Mile balance is 49,990 Big Airline Miles.

In this example, the system deducts a service fee of 20% of Mike's entry fee (i.e., a service fee of 2 Big Airline Miles), and adds the remaining 8 Big Airline Miles of Mike's entry fee to an award pool including the entry fees of other members participating in the tournament. In this example, Mike wins the tournament, and is provided with 65% of the award pool. Other tournament winners (such as the second through ninth place finishers) are provided portions of the remaining 35% of the award pool. Thus, regardless of which member(s) wins the tournament, the completed tournament results in a net quantity of loyalty points being removed from circulation and, therefore, from loyalty program providers' balance sheets, due to the service fee.

It should be appreciated that the tournament may be a tournament in which members play one or more skill games, a tournament in which members play one or more games of chance (such as a slot tournament), or a tournament in which members play one or more skill games and one or more games of chance. It should also be appreciated that, as explained above, virtual items and/or real-world items may be provided as awards for the tournament in addition to or instead of loyalty points in certain embodiments.

In certain embodiments in which the tournament enables members to play one or more skill games, the system groups members of similar skill level together to create a relatively level playing field within each tournament. For instance, the system ensures that highly skilled members play in one tournament, members of average skill play in a separate tournament, and low skill members play in another separate tournament.

2. Head-to-Head Play

i. Head-to-Head Tournament Play

In certain embodiments, the system enables two members to play a game or games against one another in a head-to-head (i.e., a one on one) tournament setting. In one embodiment, the system enables one member to challenge another member to compete in a head-to-head tournament. In another embodiment, the system enables two members to indicate a desire to enter a head-to-head tournament. In a further embodiment, the system enables a member to request that the system find the member an opponent of a similar skill level for a head-to-head tournament. The system requires both members to pay an entry fee of a quantity of loyalty points. In this embodiment, the system pools the entry fees together, retains a service fee from the pooled entry fees and removes the retained loyalty points from circulation (as described above), and creates an award pool including the remaining portions of the entry fees. The system enables the members to play the head-to-head tournament, and provides the award pool to the winner. Thus, regardless of which member(s) wins the head-to-head tournament, each completed head-to-head tournament results in a net quantity of loyalty points being removed from circulation and, therefore, from loyalty program providers' balance sheets, due to the service fee.

ii. Head to Head Non-Tournament Play

In various embodiments, the system enables two members to play a certain game or games against one another in a non-tournament setting. In one example, the system enables two members to play a poker game, such as Texas Hold'em, against one another. In this example, for a play of the poker game, the system enables the members to place wagers and contribute to the pot using their loyalty point balances. The system determines a winner of the play of the poker game, deducts a portion of the pot as a service fee (i.e., deducts the “rake” as described above), provides the remaining pot to the winning member. Thus, in this example, the system deducts a service fee via a rake rather than requiring payment of an entry fee. Thus, regardless of which member(s) wins each final pot, each completed play results in a net quantity of loyalty points being removed from circulation and, therefore, from loyalty program providers' balance sheets, due to the rake.

3. Single Play

In certain embodiments, the system enables a member to play one or more games alone, against the house, or against a simulated or computer player. In one example, the system requires a member to pay an entry fee of a quantity of loyalty points to play a skill game in which the member wins double that quantity of loyalty points if the member achieves a certain score. In another example, the system enables a member to play a blackjack game against the “house” (i.e., a computer-controlled dealer). In this example, the system operates the blackjack game similar to a conventional blackjack game, but in which currency is replaced with loyalty points. In this example, since the “house” has an advantage over the member in blackjack, the system retains more loyalty points, on average, than it pays out to the member. In another example, the system enables a member to play Texas Hold'em head to head against a simulated player (i.e., a computer-controlled player). In this example, the system retains a rake of 5% of each pot of loyalty points won by the member. It should be appreciated that, in certain such embodiments, the system configures the paytables for such single play games such that, on average, more loyalty points are removed from circulation than are added to circulation through loyalty point awards (if any) provided to members, thereby causing a steady stream of loyalty points to be removed from circulation and from the loyalty program providers' balance sheets.

In certain such embodiments in which the system enables a member to play skill games, the system dynamically varies the paytables employed for the skill games based on how good the member is at playing those skill games. For instance, if the member is highly skilled at Skill Game A, the system alters the paytable associated with Skill Game A over time such that the difficulty of obtaining an award in Skill Game A is relatively equal among members with different skill levels.

### J. Using Loyalty Points to Purchase Items and Services

In various embodiments, the loyalty point reduction system enables members to use their loyalty points to purchase items and/or services to enhance their gaming experiences. As described in more detail below, the reduction system may offer virtual items and services (i.e., items and services that do not have monetary value) and/or real-world items and services (i.e., items and services that have monetary value) for sale. Additionally, the system may enable members to purchase such items and services or may offer such items and services for sale at one or more different points in time such as before, during, or following play of a game.

1. Virtual Items and Services

In various embodiments, the system enables a member to use loyalty points to purchase game “power-ups” that improve the members performance(s) in one or more games. In one example, a purchasable “power-up” increases an amount of time a member has to complete a play of a game. In another example, a purchasable “power-up” increases the speed at which a member performs certain moves during a play of a game. In a further example, a purchasable “power-up” increases a score or a number of points associated with certain events that occur during play of a game. In one example, a purchasable “power-up” enables the member to pause the game for a certain amount of time. In another example, a purchasable “power-up” enables the member to start a game with a number of additional items. In a further example, a purchasable “power-up” entitles the member to a certain number of bonuses during play of a game. In one example, a purchasable “power-up” provides an automatic win of a game. It should be appreciated that such purchasable “power-ups”may cost any suitable quantity of loyalty points. In one embodiment, rarer or more beneficial “power-ups” cost more loyalty points than more common or less beneficial “power-ups.”

In certain embodiments, the system enables a member to use loyalty points to purchase “prize boosts” that increase the member's award for a play of a game. For instance, the loyalty point reduction system may enable the member to pay a quantity of loyalty points to receive: a 5% prize increase, a 10% prize increase, a 15% prize increase, a 20% prize increase, a 25% prize increase, or a 50% prize increase. In one embodiment, the system requires the member to pay more loyalty points for a greater prize increase. In another embodiment, the system requires the member to pay a predetermined quantity of loyalty points, and randomly selects one of the prize increases to provide to the member.

In other embodiments, the system enables a member to use loyalty points to purchase “lucky charms.” In one example, the system enables the member to purchase a ladybug, a horseshoe, a rabbit's foot, a key, a charm bracelet, a four leaf clover, a pot of gold, and/or a unicorn using the member's loyalty points. In one embodiment, such “lucky charms” benefit the member in one or more ways, such as by rendering the member eligible for a randomly-triggered bonus. In another embodiment, such items do not influence game play (i.e., are “vanity items”).

In various embodiments, the system enables a member to use loyalty points to unlock content. That is, in this embodiment, a member is unable to access certain content unless and until the member pays a quantity of loyalty points to unlock that content. Examples of unlockable content include unlockable games, unlockable bonuses, unlockable purchasable items, and unlockable play modes. It should be appreciated that, in other embodiments, the system requires other conditions to be met for unlockable content to be unlocked, such as requiring the possession of a certain item or items, the achievement of a certain level (such as a certain level in a game or a certain experience level), or the completion of a certain mission.

In certain embodiments, the system does not enable members to pay loyalty points to play a certain game. Rather, the system requires that members pay game credits (which are different than loyalty points) to play that game. In this embodiment, the system enables members to purchase game credits using loyalty points, and then use those game credits to play that game.

In other embodiments, the system provides one or more missions to a member that, if completed, cause the system to provide the member an achievement award. In one such embodiment, the system enables members to pay loyalty points to complete one or more tasks or goals of the mission without actually performing those tasks through game play. For instance, the system presents a mission to the member to collect a set of five specific virtual items. Each of those virtual items is awardable through play of a different game. In this example, the member collects four of the virtual items through play of the games and uses the member's loyalty points to purchase the fifth virtual item to complete the set, causing the system to provide the member an achievement award.

In one embodiment, the system enables members to purchase one or more vanity items that do not affect game play but that affect the look and feel of the members' experiences. In one example, each member is associated with an avatar, as shown in FIGS. 3B to 3F (described above). In this example, the system enables members to use loyalty points to purchase items or upgrades for their avatars, such as clothing, accessories, hairstyles, and tattoos. In another example, the system enables members to purchase different skins for one or more games. In a further example, the system enables members to purchase different in-game music for one or more games.

In various embodiments, the loyalty point reduction system enables member to use loyalty points to purchase or subscribe to a higher membership tier. In one example, a member who pays loyalty points to subscribe to a higher membership tier is provided an advertisement-free gaming experience. That is, the gaming UI does not display advertisements to that member. In another example, a member who pays loyalty points to subscribe to a higher membership tier is provided exclusive content (such as exclusive games), exclusive or customizable artwork or skins, or exclusive music.

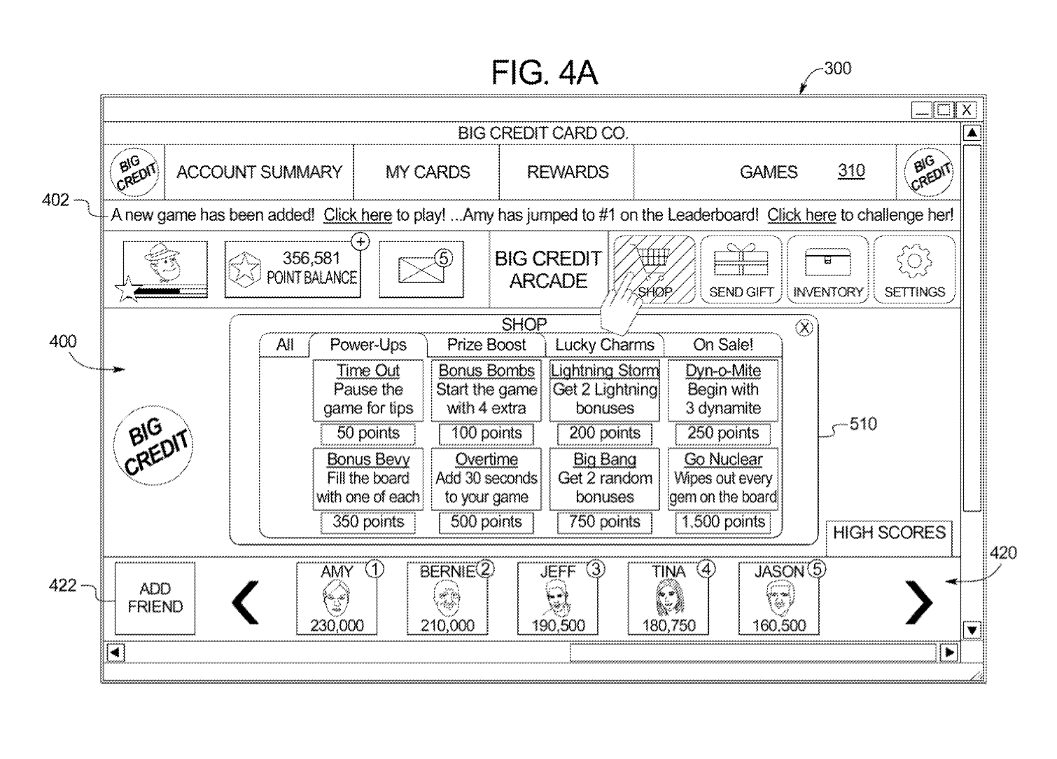

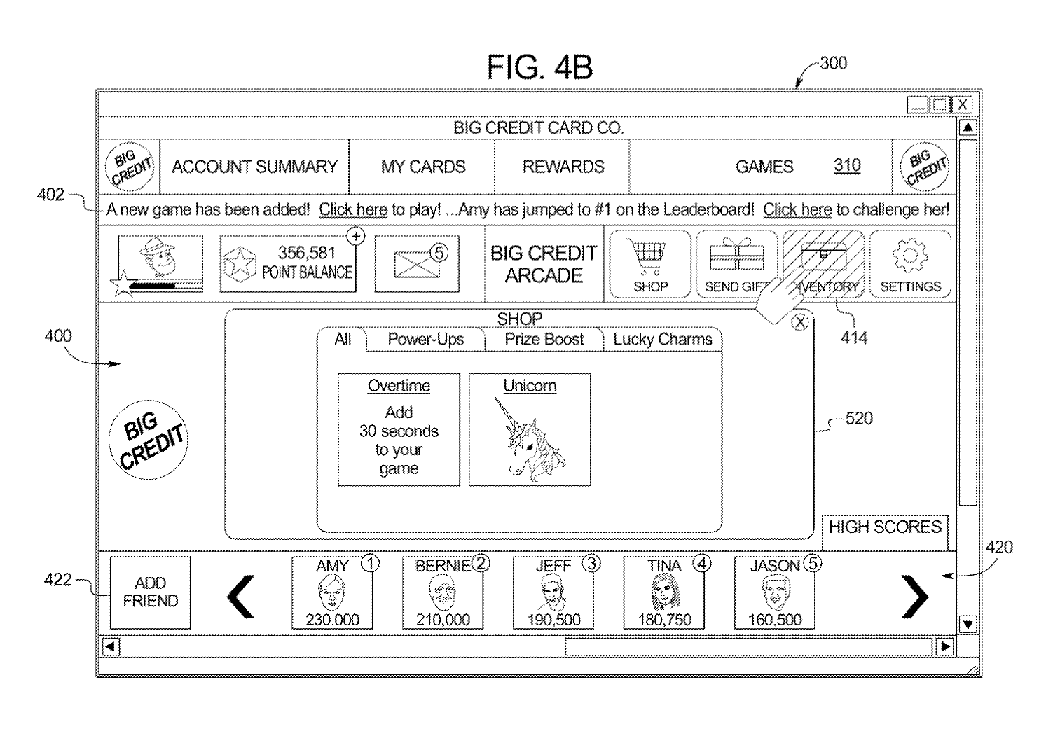

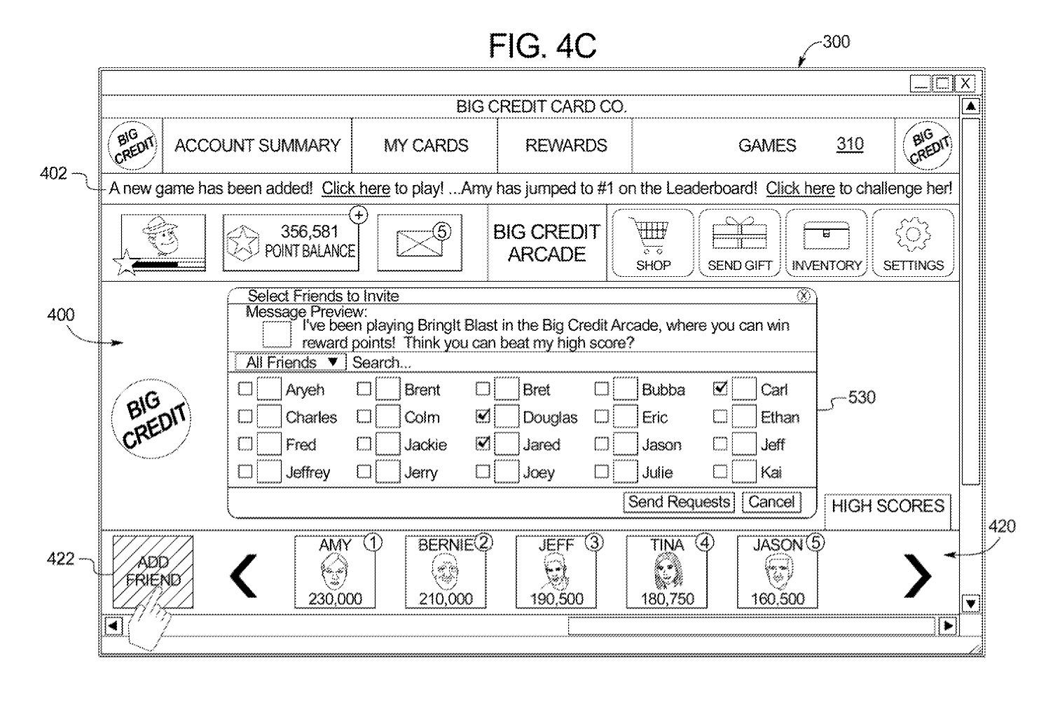

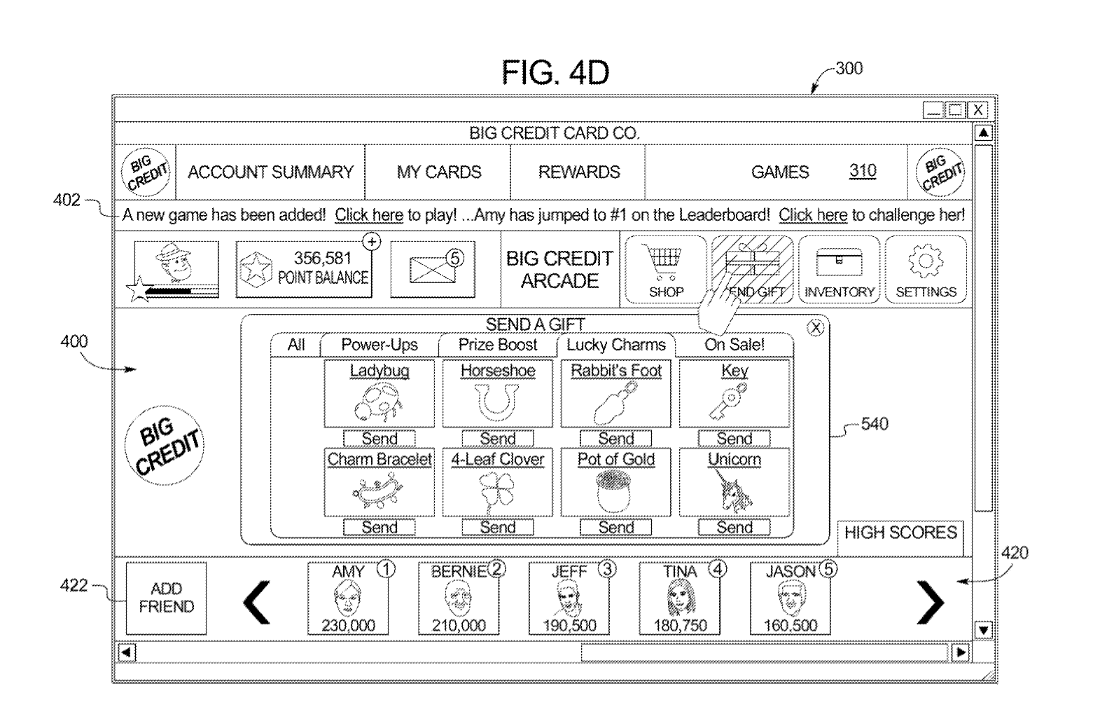

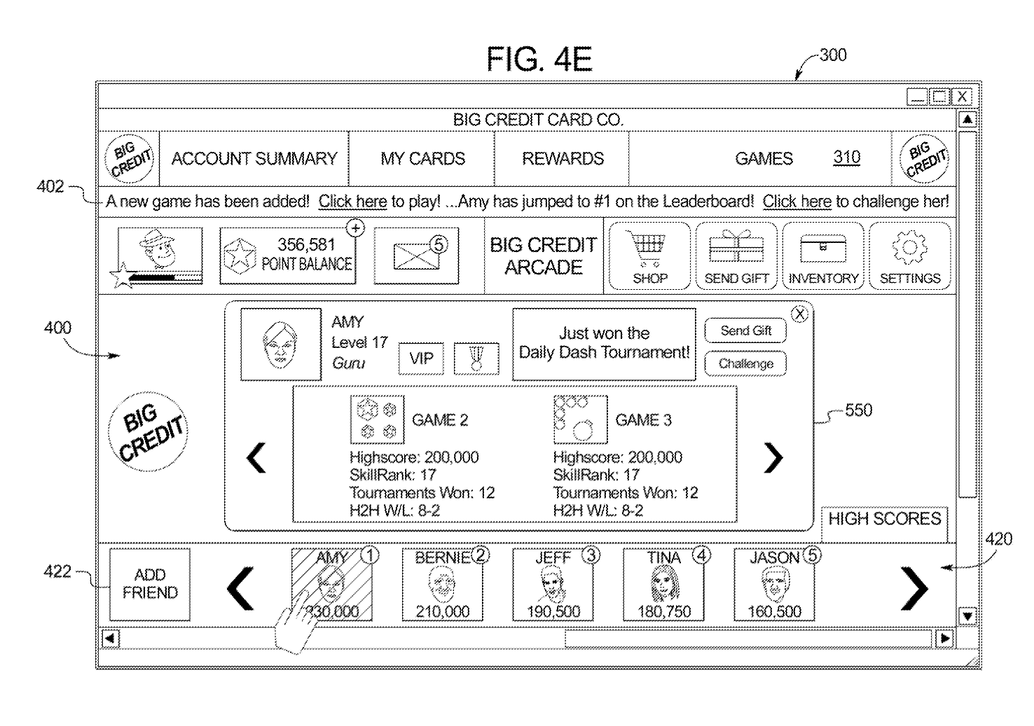

FIG. 4A illustrates a screen shot of an example of the gaming UI when the member clicks on or otherwise selects shop icon or button 410. In this example, when the member clicks on or otherwise selects shop icon or button 410, the system displays a pop-up window 510 including a plurality of different purchasable items and services, which are sorted into different tabs. In the illustrated example, the “Power-Ups” tab is selected, and the member is able to browse through various “power-ups” that the member may purchase using loyalty points. In this example, though not shown, the system enables the member to search the shop (such as via keyword search) or filter through the various purchasable items and services available through the shop using one or more filters.

FIG. 4B illustrates a screen shot of an example of the gaming UI when the member clicks on or otherwise selects inventory icon or button 414. In this example, when the member clicks on or otherwise selects inventory icon or button 414, the system displays a pop-up window 520 including the items purchased by, won by, or gifted to the member, and sorts such items into different tabs. In the illustrated example, the “All” tab is selected, and the member is able to browse through the member's various items.

2. Real-World Items and Services

In certain embodiments, the loyalty point reduction system enables members to use their loyalty points to purchase real-world items and/or services and/or opportunities to win real-world items and/or services.

In one example, the system enables a member to pay a quantity of loyalty points to enter the member into a drawing for one or more real-world prizes (such as a car, a computer, a vacation, and the like).

In another example, the system enables a member to pay a designated quantity of loyalty points in exchange for a randomly determined award of an assortment of real-world awards.

In a further example, the system enables a member to purchase a real-world item using loyalty points and provides the member with an opportunity to win a second real-world item.

In one example, the system enables a member to donate loyalty points to charity, and in return provides the member with an opportunity to win a real-world award.

In another example, the system enables a member to purchase additional loyalty points using currency. For instance, the system enables a member whose loyalty point balance has reached zero to pay $10 to purchase 1,000 loyalty points and continue playing games.

3. Timing

In certain embodiments, the system always enables a member to access the shop and purchase certain items or services. In other embodiments, however, the system offers certain items or services for purchase when certain triggering conditions are met, such as after: (a) a member has a large win, (b) a member gains a new level in a game, (e) a member receives a gift from a friend, (d) a member completes a certain mission of a game, (e) a member completes a collection of virtual items, (f) a member earns a badge for satisfying certain conditions (such as completing a certain set of tasks in a game), (g) a member sets a new high score, (h) play of a secondary or bonus game; (i) any winning outcome occurs for a play of the game; (j) one or more designated outcomes occur for a play of the game; (k) a member wins a jackpot award, progressive award, or other designated award; (l) a member wins at least a designated amount of loyalty points; (m) a member achieves a designated quantity of consecutive winning outcomes; (n) a member's loyalty point balance reaches a designated level; (o) a member accumulates a designated quantity of friends; (p) any losing outcome occurs for a play of a game; (q) a designated losing outcome occurs for a play of a game; (r) for a play of a game, a member receives an award of a quantity loyalty points that is less than a quantity of loyalty points the member paid to play the game; (s) a member's loyalty point balance falls below a certain quantity; and/or (t) a member achieves a designated quantity of consecutive losing outcomes.

It should be appreciated that, in certain embodiments, the items or services offered following the occurrence of the triggering condition(s) are not otherwise offered to members. For instance, when a member wins a jackpot award, the system enables the member to exchange the jackpot award for a free first class flight, and otherwise does not enable members to use loyalty points to purchase the free first class flight.

In other embodiments, the items or services offered following the occurrence of the triggering condition(s) are otherwise available for purchase, but are offered at a discount following the occurrence of the triggering condition(s). For example, when a member sets a new high score for a game, the system enables the member to redeem a quantity of loyalty points to receive a 40% discount at a clothing store, and otherwise enables members to redeem the same quantity of loyalty points to receive a 20% discount at the clothing store. In another example, when a member wins an award of 25,000 loyalty points for a play of a game, the system displays the following offer to the member: “Congratulations, you just, won 25,000 points! You can redeem those 25,000 points for a ticket that would normally cost 30,000 points if you act now!”

In other examples, when one or more of the triggering conditions are met, the system: (a) displays an offer to the member to redeem loyalty points to purchase a virtual good; (b) displays an offer to the member to complete a credit card application or sign up for a product trial; (c) encourages the member to invite friends, challenge friends to play games, and/or send gifts to friends (as described below); and/or (d) encourages the member to post about the member's activity to a social network.

### K. Social Media Integration

The present disclosure contemplates enabling the loyalty point reduction system to integrate with one or more social media accounts of a member to enhance the member's gaming experience by tying that experience to the member's friends or contacts within the member's social media account(s).

In one embodiment, the system enables a member to invite the member's friends or contacts in the member's social medial account to join the loyalty program and/or to participate in the system and use their loyalty points to play games. For example, the system enables the member to click or otherwise select an “Add Friend” icon or button (such as that shown in FIG. 3B) to request that the system send an email, notification, or other message to one or more of the member's friends or contacts informing the friends or contacts that the member is inviting them to join the loyalty program or to play games using the system.

FIG. 4C illustrates a screen shot of an example of the gaming UI when the member clicks on or otherwise selects send add friend icon or button 422. In this example, when the member clicks on or otherwise selects add friend icon or button 422, the system displays a pop-up window 530 including certain of the friends or contacts in the member's social media account who are not members of the loyalty program. In the illustrated example, the system enables the member to select certain of the member's friends or contacts and to cause the system to send a request that those friends or contacts join the loyalty program.

In another embodiment, the system displays one or more leaderboards to the member, such as leaderboard 420 illustrated in FIG. 4B, that include high score rankings of the member's friends or contacts for one or more games. It should be appreciated that the system may additionally or alternatively display a global leaderboard that includes overall high score rankings for one or more games (not just those of the member's friends or contacts).

In a further embodiment, the system enables a member to send a virtual item to one of the member's friends or contacts as a gift. To accept or “open” the gift, the member's friend logs into the system and affirmatively “open” the gift. It should be appreciated that, in certain embodiments, the system enables members to send gifts to friends or contacts who are already part of the loyalty program, while in other embodiments the system enables member to send gifts to friends or contacts who are not part of the loyalty program to provide those friends or contacts an incentive to join the loyalty program. In one embodiment, the system requires the member to purchase a gift (such as by paying a quantity of loyalty points) before sending that gift to one of the member's friends. In another embodiment, the system does not require the member to purchase a gift before sending that gift to a friend. In a further embodiment, the system enables the member to send an item from the member's inventory to a friend as a gift. In one embodiment, the system enables members to request gifts or virtual items from friends or contacts. For instance, if a member needs one remaining virtual item to complete a collection (and thus receive an achievement award), the system enables the member to send a gift or item request to the member's friends asking for that virtual item.

FIG. 4D illustrates a screen shot of an example of the gaming UI when the member clicks on or otherwise selects send gift icon or button 412. In this example, when the member clicks on or otherwise selects send gift icon or button 412, the system displays a pop-up window 540 including items available to send to a friend of the member, and sorts such items into different tabs. In the illustrated example, the “Lucky Charms” tab is selected, and the member is able to browse through various lucky charms that the member may send to a friend.

In one embodiment, the system enables a member to challenge one of the member's friends or contacts to a head-to-head challenge. For instance, the system enables the member to send a message to one of the member's friends that states: “John challenges you a head-to-head competition in Turkey Bowl! Do you have what it takes to beat him?!” In another embodiment, the system enables a member to create a tournament and invite the member's friends or contacts to play in the tournament. In one example, the tournament is exclusive to the member's friends or contacts, while in another example the tournament is not exclusive to the member's friends or contacts.

FIG. 4E illustrates a screen shot of an example of the gaming UI when the member clicks on or otherwise selects one of the member's friend's avatars in the leaderboard 420. In this example, when the member click on or otherwise selects one of the member's friend's avatars, the system displays a pop-up window 550 including information about the member's friend, such as high scores; experience levels; virtual badges, ribbons, and/or trophies the member's friend has won; and selectable icons or buttons that enable the member to send a gift to the member's friend and/or challenge the member's friend to play a game.

In a further embodiment, the system enables a member to send messages or notifications to the member's friends or contacts or enables a member to authorize the system to automatically send messages or notifications to the member's friends or contacts. In one example, whenever a member beats one of the member's friend or contacts' high scores, the system sends a message or a notification (such as by sending an email, sending an instant message, sending a text message, or posting on that friend's or contact's social messaging page or feed) to that friend or contact informing that friend or contact that the member beat the friend or contact's high score. Similarly, the system enables a member to share the member's accomplishments, such as achieving a new high score, being provided a large or notable award, being provided a rare or notable achievement award, and the like. The system enables the member to do so via messages or notifications to the member's friends or contacts, or by posting (or enabling the system to automatically post) such accomplishments on the member's social network page or feed.

In a further embodiment, the system enables a member and the member's friends or contacts to collectively complete a mission and earn achievement awards. In one example, the system provides a mission to a group of members that requires the members to, collectively, collect or accumulate a quantity of specific virtual items. In this example, the system provides each of the members of the group with an achievement award when the members collectively accumulate all of those virtual items.

### L. Free Play

In certain embodiments, the loyalty point reduction system includes a free play, trial play, or a demo play mode that enables persons who are not members of the loyalty program to play one or more games or otherwise experience the system. That is, the system enables a person to try out the system to determine whether the person wants to sign up for the loyalty program to use the system to play games using accumulated loyalty points. It should be appreciated that the system may provide a “scaled down” version of the gaming UI during play in the free play, trial play, or demo play mode in certain embodiments. In other embodiments, however, the system provides the “full” version of the gaming UI during play in the free play, trial play, or demo play mode.

In one such embodiment, the system does not enable non-members to wager or pay loyalty points to play games; rather, the system provides the non-members with a certain quantity of “free play” credits that the non-members may use to play games alone, against other non-members, or against the “house” to win “free play” credits. That is, in this embodiment, the system separates non-members and members and does not enable them to interact or play games with one another.

In another such embodiment, the system provides a non-member with a certain quantity of loyalty points to enable the non-member to “try out” the system. In this embodiment, the system enables the non-member to play games using those loyalty points alone, against other members (or non-members), or against the “house.” In a further such embodiment, the system provides a member with a certain quantity of loyalty points to enable the member to “try out” the system. That is, in this embodiment, the system enables those who are already members of the loyalty program to participate in a trial period so the members can determine whether they enjoy playing games using their loyalty points.

In other embodiments, the system enables members to participate in the free play, trial play, or demo play mode. In these embodiments, the free play, trial play, or demo play mode is a “practice mode” that members may use to hone their skills or try out new games without paying any loyalty points. It should be appreciated, however, that members participating in the free play, trial play, or demo play mode may not win any loyalty points.

### M. Computing Devices

1. System and Member Access Devices

It should be appreciated that the above-described embodiments of the loyalty point reduction system of the present disclosure may be implemented in accordance with or in conjunction with one or more of a variety of different types of computing devices, such as, but not limited to, various configurations of one or more central servers, central controllers, or remote hosts. It should also be appreciated that the member access devices configured to operate with the system of the present disclosure may include different types of computing devices, such as, but not limited to, various configurations of one or more desktop computers, laptop computers, or tablet computers or computing devices; one or more personal digital assistants (PDAs); and/or one or more mobile telephones such as smart phones and other mobile computing devices.

In certain embodiments, the system and the member access device each include at least one processor and at least one memory device or storage device. The at least one processor of the system is configured to transmit and receive data or signals representing events, messages, commands, or any other suitable information between the system, the member access device(s) and the loyalty program provider system(s). The at least one processor of the system is configured to execute the events, messages, or commands represented by such data or signals in conjunction with the operation of the central server, central controller, or remote host. In certain such embodiments, computerized instructions for controlling the gaming UI and any games displayed by the member access device(s) are executed by the system. In such “thin client” embodiments, the system remotely controls the gaming UI and any games (or other suitable interfaces) displayed by the member access device(s), and the member access device(s) is utilized to display such gaming UI and games (or suitable interfaces) and to receive one or more inputs or commands.

As generally noted above, the at least one processors of the system and the member access device are configured to communicate with, configured to access, and configured to exchange signals with at least one memory device or data storage device. In various embodiments, the at least one memory devices of the system and the member access device include random access memory (RAM), which can include non-volatile RAM (NVRAM), magnetic RAM (MRAM), ferroelectric RAM (FeRAM), and other common forms. In other embodiments, the at least one memory devices include read only memory (ROM). In certain embodiments, the at least one memory devices include flash memory and/or EEPROM (electrically erasable programmable read only memory). It should be appreciated that any other suitable magnetic, optical and/or semiconductor memory may operate in conjunction with the system and the member access device disclosed herein.

In various embodiments, the member access device includes at least one input device and at least one output device. In various embodiments, the input devices may include any suitable device that enables an input signal to be produced and received by the at least one processor of the member access device. In certain embodiments, one input device of the member access device is a touch-screen coupled to a touch-screen controller or other touch-sensitive display overlay to enable interaction with any images displayed on a display device (as described below). The touch-screen and the touch-screen controller are connected to a video controller. In these embodiments, signals are input to the member access device by touching the touch screen at the appropriate locations.

In various embodiments, one input device of the member access device is a sensor, such as a camera, in communication with the at least one processor of the member access device (and controlled by the at least one processor of the member access device in some embodiments) and configured to acquire an image or a video of a member using the member access device and/or an image or a video of an area surrounding the member access device.

In various embodiments, the member access device includes one or more output devices. One or more output devices of the member access device are one or more display devices configured to display any game(s) displayed by the member access device and any suitable information associated with such game(s). In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

In certain embodiments, one output device of the member access device is a sound generating device controlled by one or more sound cards. In one such embodiment, the sound generating device includes one or more speakers or other sound generating hardware and/or software for generating sounds, such as by playing music for any games or by playing music for other modes of the member access device.

It should be appreciated that the central server, central controller, or remote host, and the member access device(s) are configured to connect to a data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for members to use a variety of member access devices to access the gaming UI and play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with members.

2. Operation of Games of Chance

In certain embodiments, the system randomly determines any game outcome(s) (such as a win outcome) and/or award(s) (such as a quantity of loyalty points to award for the win outcome) for a play of a game based on probability data. In certain such embodiments, this random determination is provided through utilization of a random number generator (RNG), such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award. At least U.S. Pat. Nos. 7,470,183; 7,563,163; and 7,833,092 and U.S. Patent Application Publication Nos. 2005/0148382, 2006/0094509, and 2009/0181743 describe various examples of this type of award determination.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos, 7,753,774; 7,731,581; 7,955,170; and 8,070,579 and U.S. Patent Application Publication Ho, 2011/0028201 describe various examples of this type of award determination.

As noted above, in various embodiments, the system includes one or more executable game programs executable by at least one processor of the system to provide one or more games. The games may comprise any suitable skill games and/or games of chance (as described above), such as, but not limited to: slot or spinning reel type games; card games such as video draw poker, multi-hand draw poker, other poker games, blackjack games, and baccarat games; keno games; bingo games; and selection games.

In certain embodiments in which the game is a slot or spinning reel type game, the system includes one or more simulated reels in video form. Each reel displays a plurality of indicia or symbols, such as bells, hearts, fruits, numbers, letters, bars, or other images that typically correspond to a theme associated with the system. For instance, the symbols in certain embodiments are associated with or representative of the loyalty program provider associated with the system. In certain such embodiments, the system includes one or more paylines associated with the reels. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No 8,012,011 and U.S. Patent Application Publication Nos. 2008/0108408 and 2008/0132320 describe various examples of ways to win award determinations.

In various embodiments, the system includes a progressive award. Typically, a progressive award includes an initial amount and an additional amount funded through a portion of each wager placed to initiate a play of a game. When one or more triggering events occurs, the system provides at least a portion of the progressive award. After the system provides the progressive award, an amount of the progressive award is reset to the initial amount and a portion of each subsequent wager is allocated to the next progressive award. At least U.S. Pat. Nos. 5,766,079; 7,585,223; 7,651,392; 7,666,093; 7,780,523; and 7,905,778 and U.S. Patent Application Publication Nos. 2008/0020846, 2008/0123364, 2009/0123363, and 2010/0227677 describe various examples of different progressive systems.

As generally noted above, in addition to providing winning credits or other awards for one or more plays of the game(s), which are primary games in certain embodiments, in various embodiments the system provides credits or other awards for one or more plays of one or more secondary or bonus games. The secondary game typically enables a prize or payout in to be obtained addition to any prize or payout obtained through play of the primary game(s). The secondary game(s) typically produces a higher level of member excitement than the primary game(s) because the secondary game(s) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of plays, a number of credits, or an amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for the providing of the secondary game. In this embodiment, qualifying for a secondary game is not triggered by the occurrence of an event in any game or based specifically on any of the plays of any game. That is, qualification is provided without any explanation or, alternatively, with a simple explanation. In another such embodiment, the system determines qualification for a secondary game at least partially based on a game triggered or symbol triggered event, such as at least partially based on play of a game.

In various embodiments, after qualification for a secondary game has been determined, the secondary game participation may be enhanced through continued play on the game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system is configured to operate with a plurality of member access devices, the system provides a group gaming environment. In certain such embodiments, the system enables members to work in conjunction with one another, such as by enabling the members to play together as a team or group, to win one or more awards. In other such embodiments, the system enables members to compete against one another for one or more awards. In one such embodiment, the system enables members to participate in one or more gaming tournaments for one or more awards. At least U.S. Patent Application Publication Nos. 2007/0123341, 2008/0070680, 2008/0176650, and 2009/0124363 describe various examples of different group gaming systems.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of operating a system, said method comprising:
causing at least one processor to execute a plurality of instructions stored in at least one memory device to:
(a) receive a request from a member of a loyalty program provided by a loyalty program provider to play one of a plurality of different games;
(b) receive a request from the member to play the requested game in one of one or more different play modes;
(c) determine and cause a display device to display an entry fee associated with the requested game and the requested play mode, the entry fee including a designated quantity of loyalty points associated with the loyalty program;
(d) instruct the loyalty program provider to deduct the entry fee from a loyalty point balance of the member;
(e) cause the display device to display a play of the requested game in the requested play mode;
(f) determine an outcome for the play of the game;
(g) determine any loyalty point awards based on the determined outcome; and
(h) instruct the loyalty program provider to add any determined loyalty point awards to the loyalty point balance of the member.

2. The method of claim 1, wherein the plurality of games includes at least one of: a game of skill and a game of chance.

3. The method of claim 1, wherein the one or more different play modes include at least one of: a single player mode, a head to head mode, and a tournament mode.

4. The method of claim 1, which includes causing the at least one processor to execute the plurality of instructions to deduct a service fee from any determined loyalty point awards before instructing the loyalty program provider to add any determined loyalty point awards to the loyalty point balance of the member.

5. The method of claim 1, which includes causing the at least one processor to execute the plurality of instructions to:
(a) receive a request from the member to purchase a virtual item;
(b) instruct the loyalty program provider to deduct a quantity of loyalty points associated with the loyalty point program from the loyalty point balance of the member, the quantity of loyalty points representing a cost of the virtual item; and
(c) provide the purchased virtual item to the member.

6. The method of claim 1, which is provided through a data network.

7. The method of claim 6, wherein the data network is an internet.

8. A method of operating a system, said method comprising:
causing at least one processor to execute a plurality of instructions stored in at least one memory device to:
(a) receive a request from a member of a loyalty program provided by a loyalty program provider to play one of a plurality of different games;
(b) receive a request from the member to play the requested game in one of one or more different play modes;
(c) determine cause a display device to display an entry fee associated with the requested game and the requested play mode, the entry fee including a designated quantity of loyalty points associated with the loyalty program;
(d) instruct the loyalty program provider to deduct the entry fee from a loyalty point balance of the member;
(e) cause the display device to display a play of the requested game in the requested play mode;
(f) determine an outcome for the play of the game;
(g) determine any awards based on the determined outcome, any determined awards not including any loyalty points; and
(h) cause any determined awards to be provided to the member.

9. The method of claim 8, wherein the plurality of games includes at least one of: a game of skill and a game of chance.

10. The method of claim 8, wherein the one or more different play modes include at least one of: a single player mode, a head to head mode, and a tournament mode.

11. The method of claim 8, which includes causing the at least one processor to execute the plurality of instructions to:
(a) receive a request from the member to purchase a virtual item;
(b) instruct the loyalty program provider to deduct a quantify of loyalty points associated with the loyalty point program from the loyalty point balance of the member, the quantity of loyalty points representing a cost of the virtual item; and
(c) provide the purchased virtual item to the member.

12. The method of claim 8, which is provided through a data network.

13. The method of claim 12, wherein the data network is an internet.

14. A method of operating a system, said method comprising:
causing at least one processor to execute a plurality of instructions stored in at least one memory device to:
(a) receive a request from a first member of a first loyalty program provided by a first loyalty program provider to play a game in a tournament play mode;
(b) receive a request from a second different member of a second different loyalty program provided by a second different loyalty program provider to play the game in the tournament play mode;
(c) determine and cause a first display device to display a first entry fee to the first member, the entry fee including a designated quantity of loyalty points associated with the first loyalty program;
(d) determine and cause a second different display device to display a second different entry fee to the second member, the second entry fee including a designated quantity of loyalty points associated with the second loyalty program;
(e) instruct the first loyalty program provider to deduct the first entry fee from a loyalty point balance of the first member and add a portion the first entry fee to an award pool, said portion of the first entry fee being less than the entire first entry fee;
(f) instruct the second loyalty program provider to deduct the second entry fee from a loyalty point balance of the second member and add a portion the second entry fee to the award pool, said portion of the second entry fee being less than the entire second entry fee;
(g) display the tournament and determine one or more tournament winners;
(h) if the first member is one of the tournament winners, instruct the loyalty program provider to add at least a portion of the award pool to the loyalty point balance of the first member; and
(i) if the second member is one of the tournament winners, instruct the loyalty program provider to add at least a portion of the award pool to the loyalty point balance of the second member.

15. The method of claim 14, wherein the portion of the first entry fee and the portion of the second entry fee are a same percentage of the first entry fee and the second entry fee.

16. The method of claim 15, wherein the portion of the first entry fee is a first quantity of loyalty points associated with the first loyalty program and the portion and the second entry fee is a second different quantity of loyalty points associated with the second loyalty program.

17. The method of claim 15, wherein the game is one of: a game of skill and a game of chance.

18. The method of claim 15, wherein the tournament play mode is a head to head tournament play mode.

19. The method of claim 14, which is provided through a data network.

20. The method of claim 19, wherein the data network is an internet.
